(19) United States
(12) Patent Application Publication
(10) Pub. No.: US 2022/0183086 A1
(43) Pub. Date: Jun. 9, 2022

(54) User Equipment, Radio Network Node and Methods Performed Therein for Handling Communication

(71) Applicant: Telefonaktiebolaget LM Ericsson (publ), Stockholm (SE)

(72) Inventors: Walter Müller, Upplands Väsby (SE); Pontus Wallentin, Linköping (SE); Julien Muller, Rennes (FR); Thomas Johansson, Åby (SE); Johan Rune, Lidingö (SE)

(21) Appl. No.: 17/599,051

(22) PCT Filed: Mar. 27, 2020
(86) PCT No.: PCT/SE2020/050315

§ 371 Date: Sep. 28, 2021

Related U.S. Application Data
(60) Provisional application No. 62/825,060, filed on Mar. 28, 2019.

(51) Int. Cl. H04W 76/10; H04W 72/12

(52) U.S. Cl. CPC H04W 76/10; H04W 72/1205

(57) ABSTRACT

Embodiments herein disclose e.g. a method performed by a user equipment, UE, (10) for handling establishment of a connection of the UE in a wireless communication network. The UE obtains scheduling assistance information for the UE (10); and transmits to an access node, an indication of the obtained scheduling assistance information, wherein the indication is added in a message from the UE (10) to the access node for establishing the connection of the UE.

### TECHNICAL FIELD

Embodiments herein relate to a radio network node, also referred to as access node, a user equipment (UE) and methods performed therein regarding wireless communication. Furthermore, a computer program product and a computer readable storage medium are also provided herein. In particular, embodiments herein relate to handling communication e.g. handling scheduling of radio resources such as time, frequency and/or similar, in a wireless communication network.

### BACKGROUND

In a typical wireless communication network, user equipments (UE), also known as wireless communication devices, mobile stations, wireless devices, stations (STA) and/or, may communicate via a Radio Access Network (RAN) to one or more core networks (CN). The RAN covers a geographical area which is divided into service areas, also known as cells, with each cell being served by a radio network node also referred to as access node e.g., a Wi-Fi access point or a radio base station (RBS), which in some networks may also be called, for example, a NodeB, an eNodeB or a gNodeB. The cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications network (UMTS) is a third generation (3G) telecommunications network, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for user equipments. In a forum known as the Third Generation Partnership Project (3GPP), telecommunications suppliers propose and agree upon standards for e.g. third generation networks, and investigate enhanced data rate and radio capacity and upcoming generation networks. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3GPP and this work continues in the coming 3GPP releases, for example to specify a Fifth Generation (5G) network. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

With the emerging 5G technologies such as New Radio (NR), the use of very many transmit- and receive-antenna elements is of great interest as it makes it possible to utilize beamforming, such as transmit-side and receive-side beamforming. Transmit-side beamforming means that the transmitter may amplify the transmitted signals in a selected direction or directions, while suppressing the transmitted signals in other directions. Similarly, on the receive-side, a receiver may amplify signals from a selected direction or directions, while suppressing unwanted signals from other directions.

Wireless Communication Systems in 3GPP.

Consider the simplified wireless communication system illustrated in FIG. 1, with a UE 102, which communicates with one or multiple access nodes 103-104, using radio connections 107-108. The radio network nodes also referred to as access nodes 103-104 are connected to a network node 106. The access nodes 103-104 are a part of the radio access network (RAN) 100.

For wireless communication systems pursuant to 3GPP Evolved Packet System (EPS), also referred to as Long Term Evolution (LTE) or 4G, standard specifications, such as specified in 3GPP TS 36.300 and related specifications, the access nodes 103-104 corresponds typically to an Evolved NodeB (eNB) and the network node 106 corresponds typically to either a Mobility Management Entity (MME) and/or a Serving Gateway (SGW). The eNB is part of the radio access network 100, which in this case is the Evolved Universal Terrestrial Radio Access Network (E-UTRAN), while the MME and SGW are both part of the Evolved Packet Core network (EPC).

For wireless communication systems pursuant to 3GPP 5G System (5GS), also referred to as New Radio, NR, or 5G, standard specifications, such as specified in 3GPP TS 38.300 and related specifications, on the other hand, the access nodes 103-104 corresponds typically to an 5G NodeB (gNB) and the network node 106 corresponds typically to either a Access and Mobility Management Function (AMF) and/or a User Plane Function (UPF). The gNB is part of the radio access network 100, which in this case is the Next Generation Radio Access Network (NG-RAN), while the AMF and UPF are both part of the 5G Core Network (5GC). The gNB is sometimes referred to as an NG-RAN node.

To support fast mobility between NR and LTE and avoid change of core network, LTE eNBs can also be connected to the 5G-CN via NG-U/NG-C and support the Xn interface. An eNB connected to 5GC is called a next generation eNB (ng-eNB) and is considered part of the NG-RAN. LTE connected to 5GC will not be discussed further in this document; however, it should be noted that most of the solutions/features described for LTE and NR in this document also apply to LTE connected to 5GC. In this document, when the term LTE is used without further specification it refers to LTE-EPC.

UE states and state transitions.

In the 3GPP system, for each protocol layer there is a state machine, reflecting the UE states of the particular protocol layer. In the state machine of the radio resource control (RRC) layer for NR radio access technology, three states are specified as illustrated in FIG. 2: RRC_IDLE 201, RRC_INACTIVE 202 and RRC_CONNECTED 203

The RRC states reflect the UE's activity level where RRC_IDLE 201 is typically used when the UE has no ongoing data traffic, thus no activity, and RRC_CONNECTED 203 when the UE needs to send and/or receive data. RRC_INACTIVE 202 may be used as an alternative state instead of RRC_IDLE 201 when the UE's activity pattern would add significant signaling overhead using RRC_IDLE state.

The procedure to enter RRC_CONNECTED 203 from RRC_IDLE 201 is known as the “RRC connection establishment” procedure.

A UE in RRC_CONNECTED 203 will typically after a while, typically by order of an access node, such as the gNB, transit to RRC_INACTIVE 202, due to inactivity, using what is known as the “RRC Inactivation” procedure. A UE in RRC_INACTIVE 202 needs to again enter RRC_CONNECTED 203 in order to transmit or receive data. Alternatively, the UE may remain in Inactive state for as long as it remains in a certain network area, or it may be paged by the network to transition from RRC_INACTIVE 202 to RRC_IDLE 201 or enter RRC_IDLE due to other reasons, e.g. procedural errors or failures.

The procedure for entering RRC_CONNECTED 203 from RRC_INACTIVE 202 is sometimes referred to as an “RRC Resume” procedure. The RRC Resume procedure requires much less signaling than the RRC connection establishment procedure, since e.g. processing resources, transport resources and security association in the network are preserved in RRC_INACTIVE 202 and thus there is typically no need to establish those in the RRC Resume procedure. Therefore the latency before user data can be exchanged between the UE and the network is typically much shorter for a UE in RRC_INACTIVE 202 than for a UE in RRC_IDLE 201. On the other hand, a UE in RRC_INACTIVE 202 consumes a little more power as well as resources, e.g. memory, than a UE in RRC_IDLE 201.

For LTE, a similar RRC state machine is specified and the functionality similar to the NR RRC_INACTIVE state as well as an RRC Resume procedure already exists.

Random access and RRC connection establishment.

In 3GPP LTE, a request for communication is performed by initiating a random access procedure followed by an RRC Connection Establishment procedure. FIG. 3 shows a sequence that starts with a transmission of a Random Access Preamble (301), also known as “msg1”, on specifically allocated channels or resources. This random access pre-amble is, when received by a base station or eNB, followed by a random access response (302), also known as “msg2”, that includes an allocation of resources for continued signaling, in this case the RRC Connection Request (303), also known as “msg3” which is the first message in the RRC Connection Establishment procedure. In some cases, the “msg3” sent in step 303 is another message, such as a cell-radio network temporary identity medium access control control element (C-RNTI MAC CE).

It should be noted that even further communication is needed with network entities before any communication can take place, these are omitted from FIG. 3.

In 3GPP NR, the random access and RRC connection establishment procedure is similar to the corresponding LTE procedures. In the NR case, the message in step 303 is an RRCSetupRequest message or sometimes another message, such as a C-RNTI MAC CE. The message is step 304 is an RRCSetup message. The message in step 305 is an RRCSetupComplete message.

The RRC connection establishment procedure and messages are specified for NR in 3GPP TS 38.331 v. and for LTE in 3GPP TS 36.331.

Mobility in RRC_CONNECTED in LTE and NR.

Mobility in RRC_CONNECTED state is also known as handover. The purpose of handover is to move the UE 102, due to e.g. mobility, from a source access node 103, using a source radio connection 107, to a target access node 104, using a target radio connection 108. The source radio connection 107 is associated with a source cell controlled by the source access node 103. The target radio connection 108 is associated with a target cell controlled by the target access node 104. So in other words, during a handover, the UE 102 moves from the source cell to a target cell. Sometimes the source access node or the source cell is referred to as the “source”, and the target access node or the target cell is sometimes referred to as the “target”.

In some cases, the source access node 103 and target access node 104 are different nodes, such as different eNBs or gNBs. There cases are also referred to as inter-node handover, inter-eNB handover or inter-gNB handover. In other cases, the source access node 103 and target access node 104 are the same node, such as the same eNB and gNB. These cases are also referred to as intra-node handover, intra-eNB handover or intra-gNB handover and cover the cases when source and target cells are controlled by the same access node. In yet other cases, handover is performed within the same cell, and thus also within the same access node controlling that cell,—these cases are also referred to as intra-cell handover.

It should therefore be understood that the source access node 103 and target access node 104 refers to a role served by a given access node during a handover of a specific UE. For example, a given access node may serve as source access node during handover of one UE, while it also serves as the target access node during handover of a different UE. And, in case of an intra-node or intra-cell handover of a given UE, the same access node serves both as the source access node and target access node for that UE.

An RRC_CONNECTED UE in E-UTRAN or NG-RAN may be configured by the network to perform measurements of serving and neighbour cells and based on the measurement reports sent by the UE, the network may decide to perform a handover of the UE to a neighbour cell. The network then sends a Handover Command message to the UE, in LTE an RRConnectionReconfiguration message with a field called mobilityControlInfo and in NR an RRCReconfiguration message with a reconfigurationWithSync field.

These reconfigurations are actually prepared by the target access node upon a request from the source access node, over X2 or S1 interface in case of EUTRA-EPC or Xn or NG interface in case of NG-RAN-5GC, and take into account the existing radio resource control (RRC) configuration and UE capabilities as provided in the request from the source access node and its own capabilities and resource situation in the intended target cell and target access node. The reconfiguration parameters provided by the target access node contain, for example, information needed by the UE to access the target access node, e.g., random access configuration, a new cell-radio network temporary identity (C-RNTI) assigned by the target access node and security parameters enabling the UE to calculate new security keys associated to the target access node so the UE can send a Handover Complete message on SRB1, encrypted and integrity protected, based on new security keys upon accessing the target access node.

FIG. 4 summarizes the signalling flow between the UE, the source access node 103, also known as source gNB, source eNB or source cell, and target access node 104, also known as target gNB, target eNB or target cell, during a handover procedure, using 5G/NR as example.

Although the signalling flow in FIG. 4 shows a handover scenario in 5G/NR, there are some common principles for a UE performing handover, or in more general terms, mobility in RRC_CONNECTED, in LTE and NR:

Mobility in RRC_CONNECTED is Network-controlled as the network has best info regarding current situation such as load conditions, resources in different nodes, available frequencies, etc. Network can also take into account the impact from other UEs served by the network, e.g. from a resource allocation perspective.
Network prepares a target cell controlled by the target access node before the UE accesses that access node. Source access node provides the UE with the RRC configuration to be used in the target cell, including signalling radio bearer 1 (SRB1) configuration to be used by the UE when sending the handover (HO) Complete message in the target cell.
UE is provided by the target access node with a C-RNTI. The UE identifies itself by conveying the C-RNTI in message 3 (MSG3). Hence, there is no context fetching between target access node and source access node, unless a failure occurs.
To speed up the handover, network provides the UE with information how to access the target access node e.g. random access channel (RACH) configuration, so the UE does not have to acquire system information (SI) prior to the handover.
UE may be provided with contention-free random access (CFRA) resources, i.e. in that case the target access node identifies the UE from the preamble in MSG.1. The principle is that the handover procedure can always be optimized with network pre-allocated resources.
Security is prepared before the UE accesses the target cell controlled by the target access node i.e. keys must be refreshed before sending the encrypted and integrity protected HO Complete message, in LTE the RRC Connection Reconfiguration Complete message, so that the UE can be verified by the target access node.
Both full and delta reconfiguration are supported so that the HO command can be minimized.

RRC connection re-establishment.

The RRC connection re-establishment procedure is triggered by a UE in RRC_CONNECTED as a way to recover after events such as radio link failure or handover failure. In NR, the UE starts by selecting a suitable cell. It then performs a random access procedure, followed by transmitting an RRCReestablishmentRequest message to the access node controlling the selected cell. If the access node finds the UE context it responds with an RRCReestablishment message, otherwise it responds with an RRCSetup message.

The RRC connection re-establishment procedure in LTE is very similar.

The RRC connection re-establishment procedure and messages are specified for NR in 3GPP TS 38.331 and for LTE in 3GPP TS 36.331.

RRC resume.

This procedure is used to resume an RRC connection by a UE that is in RRC_INACTIVE state. Examples of events that triggers the RRC resume procedure are:

The UE has uplink data to transmit
The UE has a signaling message to transmit, such as a registration message

In NR, the procedure is initiated by the UE performing a random access procedure followed by sending an RRCResumeRequest or an RRCResumeRequest1 message. Which message to use is stated by the value of the useFullResumeID signalled in SIB1. If the access node finds the UE context it responds with an RRCResume message, otherwise it responds with an RRCSetup message. It may also respond with an RRCRelease message to order the UE back to RRC_INACTIVE or go to RRC_IDLE.

In LTE there is an RRC Resume procedure as well. The RRC connection resume procedure and messages are specified for NR in 3GPP TS 38.331 v.15.4.0 and for LTE in 3GPP TS 36.331 v.15.4.0.

Dual connectivity.

Dual Connectivity (DC) allows two base stations (access nodes) to simultaneously deliver user data to a UE. DC between LTE base stations was introduced in 3GPP Release-12, completed in March 2015, and DC-like aggregation of LTE and WLAN was introduced in 3GPP Release-13, completed in March 2016. LTE-NR dual connectivity (DC), in which user data can be exchanged between a UE and an NR base station along with the LTE connectivity. The first solution to be standardized is Evolved—Universal Terrestrial Radio Access—New Radio dual connectivity—EN-DC.

In EN-DC, the master node (MN) is LTE, and the aggregated node also referred to as the secondary node (SN) is NR. In EN-DC, a UE has a second Radio Resource Control (RRC) termination at the secondary node, unlike LTE DC where there is only one RRC termination point—at the master node. The separation of LTE and NR RRC termination points enables the secondary node, depending on network configuration, to trigger the intra-NR mobility, that is, initiating secondary node change/release/modification. In LTE DC, only the master node was able to do this.

Multi-Radio Dual Connectivity (MR-DC), described in 3GPP TS 37.340 v.15.4.0, is a generalization of the Intra-E-UTRA Dual Connectivity (DC), where a multiple Rx/Tx UE may be configured to utilize resources provided by two different nodes connected via non-ideal backhaul, one providing NR access and the other one providing either E-UTRA or NR access. One node acts as the Master Node (MN) and the other as the Secondary Node (SN). The MN and SN are connected via a network interface and at least the MN is connected to the core network.

The Secondary Node Addition procedure is used to add a Secondary Cell Group for a UE. This procedure is specified in 3GPP TS 37.340 v.15.0.0 for EN-DC and MR-DC with 5GC as follows:

Secondary Node Addition procedure for EN-DC.

The Secondary Node Addition procedure is initiated by the MN and is used to establish a UE context at the SN to provide resources from the SN to the UE. For bearers requiring secondary cell group (SCG) radio resources, this procedure is used to add at least the first cell of the SCG. This procedure can also be used to configure an SN terminated master cell group (MCG) bearer, where no SCG configuration is needed. FIG. 5 shows the Secondary Node Addition procedure for EN-DC.

1. The MN decides to request the SN to allocate resources for a specific E-UTRAN Radio Access Bearer (E-RAB) indicating E-RAB characteristics, E-RAB parameters, Transport Network Layer (TNL) address information corresponding to bearer type. In addition, for bearers requiring SCG radio resources, MN indicates the requested SCG configuration information, including the entire UE capabilities and the UE capability coordination result. In this case, the MN also provides the latest measurement results for SN to choose and configure the SCG cell(s). The MN may request the SN to allocate radio resources for split SRB operation. The MN always provides all the needed security information to the SN, even if no SN terminated bearers are setup, to enable SRB3 to be setup based on SN decision. In case of bearer options that require X2-U resources between the MN and the SN, the MN provides X2-U TNL address information for the respective E-RAB, X2-U DL TNL address information for SN terminated bearers, X2-U UL TNL address information for MN terminated bearers. In case of SN terminated split bearers the MN provides the maximum quality of service (QoS) level that it can support. The SN may reject the request.

NOTE 1: For split bearers, MCG and SCG resources may be requested of such an amount, that the QoS for the respective E-RAB is guaranteed by the exact sum of resources provided by the MCG and the SCG together, or even more. For MN terminated split bearers, the MNs decision is reflected in step 1 by the E-RAB parameters signalled to the SN, which may differ from E-RAB parameters received over 51.

NOTE 2: For a specific E-RAB, the MN may request the direct establishment of an SCG or a split bearer, i.e., without first having to establish an MCG bearer. It is also allowed that all E-RABs can be configured as SN terminated bearers, i.e. there is no E-RAB established as an MN terminated bearer.

2. If the radio resource management (RRM) entity in the SN is able to admit the resource request, it allocates respective radio resources and, dependent on the bearer option, respective transport network resources. For bearers requiring SCG radio resources, the SN triggers Random Access so that synchronisation of the SN radio resource configuration can be performed. The SN decides the primary secondary cell (PScell) and other SCG Scells and provides the new SCG radio resource configuration to the MN in an NR RRC configuration message contained in the SgNB Addition Request Acknowledge message. In case of bearer options that require X2-U resources between the MN and the SN, the SN provides X2-U TNL address information for the respective E-RAB, X2-U UL TNL address information for SN terminated bearers, X2-U DL TNL address information for MN terminated bearers. For SN terminated bearers, the SN provides the S1-U DL TNL address information for the respective E-RAB and security algorithm. If SCG radio resources have been requested, the SCG radio resource configuration is provided.

NOTE 3: For the SN terminated split bearer option, the SN may either decide to request resources from the MN of such an amount, that the QoS for the respective E-RAB is guaranteed by the exact sum of resources provided by the MN and the SN together, or even more. The SNs decision is reflected in step 2 by the E-RAB parameters signalled to the MN, which may differ from E-RAB parameters received in step 1. The QoS level requested from the MN shall not exceed the level that the MN offered when setting up the split bearer in step 1.

NOTE 4: In case of MN terminated bearers, transmission of user plane data may take place after step 2.

NOTE 5: In case of SN terminated bearers, data forwarding and the SN Status Transfer may take place after step 2.

3. The MN sends to the UE the RRCConnectionReconfiguration message including the NR RRC configuration message, without modifying it.

4. The UE applies the new configuration and replies to MN with RRCConnectionReconfigurationComplete message, including an NR RRC response message, if needed. In case the UE is unable to comply with (part of) the configuration included in the RRCConnectionReconfiguration message, it performs the reconfiguration failure procedure.

5. The MN informs the SN that the UE has completed the reconfiguration procedure successfully via SgNB ReconfigurationComplete message, including the encoded NR RRC response message, if received from the UE.

6. If configured with bearers requiring SCG radio resources, the UE performs synchronisation towards the PSCell of the SN. The order the UE sends the RRCConnectionReconfigurationComplete message and performs the Random Access (RA) procedure towards the SCG is not defined. The successful RA procedure towards the SCG is not required for a successful completion of the RRC Connection Reconfiguration procedure.

7. In case of SN terminated bearers using radio link control acknowledgement mode (RLC AM), the MN sends SN Status Transfer.

8. In case of SN terminated bearers using RLC AM, and dependent on the bearer characteristics of the respective E-RAB, the MN may take actions to minimise service interruption due to activation of EN-DC (Data forwarding).

9-12. For SN terminated bearers, the update of the user plane (UP) path towards the 5GC is performed via protocol data unit (PDU) Session Path Update procedure.

Secondary Node Addition procedure for MR-DC with 5GC.

The Secondary Node (SN) Addition procedure is initiated by the MN and is used to establish a UE context at the SN in order to provide resources from the SN to the UE. For bearers requiring SCG radio resources, this procedure is used to add at least the initial SCG serving cell of the SCG. This procedure can also be used to configure an SN terminated MCG bearer, where no SCG configuration is needed. FIG. 6 shows the SN Addition procedure.

1. The MN decides to request the target SN to allocate resources for one or more specific PDU Sessions/QoS Flows, indicating QoS Flows characteristics (QoS Flow Level QoS parameters, PDU session level TNL address information, and PDU session level Network Slice info). In addition, for bearers requiring SCG radio resources, MN indicates the requested SCG configuration information, including the entire UE capabilities and the UE capability coordination result. In this case, the MN also provides the latest measurement results for SN to choose and configure the SCG cell(s). The MN may request the SN to allocate radio resources for split SRB operation. The MN always provides all the needed security information to the SN (even if no SN terminated bearers are setup) to enable SRB3 to be setup based on SN decision.

For MN terminated bearer options that require Xn-U resources between the MN and the SN, the MN provides Xn-U UL TNL address information. For SN terminated bearers, the MN provides a list of available DRB IDs. The S-NG-RAN node shall store this information and use it when establishing SN terminated bearers. The SN may reject the request.

For SN terminated bearer options that require Xn-U resources between the MN and the SN, the MN provides in step 1 a list of QoS flows per PDU Sessions for which SCG resources are requested to be setup upon which the SN decides how to map QoS flows to DRB.

NOTE 1: For split bearers, MCG and SCG resources may be requested of such an amount, that the QoS for the respective QoS Flow is guaranteed by the exact sum of resources provided by the MCG and the SCG together, or even more. For MN terminated split bearers, the MN decision is reflected in step 1 by the QoS Flow parameters signalled to the SN, which may differ from QoS Flow parameters received over NG.

NOTE 2: For a specific QoS flow, the MN may request the direct establishment of SCG and/or split bearers, i.e. without first having to establish MCG bearers. It is also allowed that all QoS flows can be mapped to SN terminated bearers, i.e. there is no QoS flow mapped to an MN terminated bearer.

2. If the RRM entity in the SN is able to admit the resource request, it allocates respective radio resources and, dependent on the bearer type options, respective transport network resources. For bearers requiring SCG radio resources the SN triggers UE Random Access so that synchronisation of the SN radio resource configuration can be performed. The SN decides for the PScell and other SCG Scells and provides the new SCG radio resource configuration to the MN in a SN RRC configuration message contained in the SN Addition Request Acknowledge message. In case of bearer options that require Xn-U resources between the MN and the SN, the SN provides Xn-U TNL address information for the respective DRB, Xn-U UL TNL address information for SN terminated bearers, Xn-U DL TNL address information for MN terminated bearers. For SN terminated bearers, the SN provides the NG-U DL TNL address information for the respective PDU Session and security algorithm. If SCG radio resources have been requested, the SCG radio resource configuration is provided.

NOTE 3: In case of MN terminated bearers, transmission of user plane data may take place after step 2.

NOTE 4: In case of SN terminated bearers, data forwarding and the SN Status Transfer may take place after step 2.

NOTE 5: For MN terminated NR SCG bearers for which PDCP duplication with CA is configured the MN allocates 2 separate Xn-U bearers.

For SN terminated NR MCG bearers for which PDCP duplication with CA is configured the SN allocates 2 separate Xn-U bearers.

2a. For SN terminated bearers using MCG resources, the MN provides Xn-U DL TNL address information in the Xn-U Address Indication message.

3. The MN sends the MN RRC reconfiguration message to the UE including the SN RRC configuration message, without modifying it.

4. The UE applies the new configuration and replies to MN with MN RRC reconfiguration complete message, including a SN RRC response message for SN, if needed. In case the UE is unable to comply with (part of) the configuration included in the MN RRC reconfiguration message, it performs the reconfiguration failure procedure.

5. The MN informs the SN that the UE has completed the reconfiguration procedure successfully via SN Reconfiguration Complete message, including the encoded SN RRC response message, if received from the UE.

6. If configured with bearers requiring SCG radio resources, the UE performs synchronisation towards the PSCell configured by the SN. The order the UE sends the MN RRC reconfiguration complete message and performs the Random Access procedure towards the SCG is not defined. The successful RA procedure towards the SCG is not required for a successful completion of the RRC Connection Reconfiguration procedure.

7. In case of SN terminated bearers using RLC AM, the MN sends SN Status Transfer.

8. In case of SN terminated bearers using RLC AM, and dependent on the bearer characteristics of the respective QoS Flows, the MN may take actions to minimise service interruption due to activation of MR-DC (Data forwarding).

9-12. For SN terminated bearers, the update of the UP path towards the 5GC is performed via PDU Session Path Update procedure.

Secondary Node Change.

Change of secondary node can be triggered in 2 ways, either by the Master Node or the Secondary node.

MN initiated SN Change:

FIG. 7 shows an example signalling flow for the MN initiated Secondary Node Change:

1/2. The MN initiates the SN change by requesting the target SN to allocate resources for the UE by means of the SgNB Addition procedure. The MN may include measurement results related to the target SN. If forwarding is needed, the target SN provides forwarding addresses to the MN. The target SN includes the indication of the full or delta RRC configuration.

NOTE 2: The MN may send the SgNB Modification Request message (to the source SN) to request the current SCG configuration before step 1.

3. If the allocation of target SN resources was successful, the MN initiates the release of the source SN resources including a Cause indicating SCG mobility. The Source SN may reject the release. If data forwarding is needed the MN provides data forwarding addresses to the source SN. If direct data forwarding is used for SN terminated bearers, the MN provides data forwarding addresses as received from the target SN to source SN. Reception of the SgNB Release Request message triggers the source SN to stop providing user data to the UE and, if applicable, to start data forwarding.

4/5. The MN triggers the UE to apply the new configuration. The MN indicates to the UE the new configuration in the RRCConnectionReconfiguration message including the NR RRC configuration message generated by the target SN. The UE applies the new configuration and sends the RRCConnectionReconfigurationComplete message, including the encoded NR RRC response message for the target SN, if needed. In case the UE is unable to comply with (part of) the configuration included in the RRCConnectionReconfiguration message, it performs the reconfiguration failure procedure.

6. If the RRC connection reconfiguration procedure was successful, the MN informs the target SN via SgNBReconfigurationComplete message with the encoded NR RRC response message for the target SN, if received from the UE.

7. If configured with bearers requiring SCG radio resources, the UE synchronizes to the target SN.

8. For SN terminated bearers using RLC AM, the source SN sends the SN Status transfer, which the MN sends then to the target SN.

9. If applicable, data forwarding from the source SN takes place. It may be initiated as early as the source SN receives the SgNB Release Request message from the MN.

10. The source SN sends the Secondary RAT Data Volume Report message to the MN and includes the data volumes delivered to the UE over the NR radio for the related E-RABs.

NOTE 3: The order the SN sends the Secondary RAT Data Volume Report message and performs data forwarding with MN is not defined. The SN may send the report when the transmission of the related bearer is stopped.

11-15. If one of the bearer was terminated at the source SN, path update is triggered by the MN.

16. Upon reception of the UE Context Release message, the source SN can release radio and C-plane related resource associated to the UE context. Any ongoing data forwarding may continue.

FIG. 8 shows an example signalling flow for the Secondary Node Change initiated by the SN:

1. The source SN initiates the SN change procedure by sending SgNB Change Required message which contains target SN ID information and may include the SCG configuration (to support delta configuration) and measurement results related to the target SN.

2/3. The MN requests the target SN to allocate resources for the UE by means of the SgNB Addition procedure, including the measurement results related to the target SN received from the source SN. If forwarding is needed, the target SN provides forwarding addresses to the MN. The target SN includes the indication of the full or delta RRC configuration.

4/5. The MN triggers the UE to apply the new configuration. The MN indicates the new configuration to the UE in the RRCConnectionReconfiguration message including the NR RRC configuration message generated by the target SN. The UE applies the new configuration and sends the RRCConnectionReconfigurationComplete message, including the encoded NR RRC response message for the target SN, if needed. In case the UE is unable to comply with (part of) the configuration included in the RRCConnectionReconfiguration message, it performs the reconfiguration failure procedure.

6. If the allocation of target SN resources was successful, the MN confirms the release of the source SN resources. If data forwarding is needed the MN provides data forwarding addresses to the source SN. If direct data forwarding is used for SN terminated bearers, the MN provides data forwarding addresses as received from the target SN to source SN. Reception of the SgNB Change Confirm message triggers the source SN to stop providing user data to the UE and, if applicable, to start data forwarding.

7. If the RRC connection reconfiguration procedure was successful, the MN informs the target SN via SgNB Reconfiguration Complete message with the encoded NR RRC response message for the target SN, if received from the UE.

8. The UE synchronizes to the target SN.

9. For SN terminated bearers using RLC AM, the source SN sends the SN Status transfer, which the MN sends then to the target SN.

10. If applicable, data forwarding from the source SN takes place. It may be initiated as early as the source SN receives the SgNB Change Confirm message from the MN.

11. The source SN sends the Secondary RAT Data Volume Report message to the MN and includes the data volumes delivered to the UE over the NR radio for the related E-RABs.

NOTE 4: The order the source SN sends the Secondary RAT Data Volume Report message and performs data forwarding with MN/target SN is not defined. The SgNB may send the report when the transmission of the related bearer is stopped.

12-16. If one of the bearer was terminated at the source SN, path update is triggered by the MN.

17. Upon reception of the UE Context Release message, the source SN can release radio and C-plane related resource associated to the UE context. Any ongoing data forwarding may continue.

Scheduling.

Scheduling is a process through which the access node, such as the eNodeB in case of LTE, decides which UEs should be given resources (such as resource blocks), and how much resources should be given to send or receive data. In LTE, scheduling is done at per subframe basis i.e. every 1 ms. The entity in the access node which performs this is also known as the scheduler.

A scheduler takes input from other nodes, such as the operation and maintenance (O&M) system, and/or a network node in the core network, as system configuration e.g. which scheduling algorithm is to be enable (round robin, Max C/I, Proportional Fair, QoS aware etc), consider QoS information (Which quality class indicator (QCI), guarantee bit rate (GBR), non-GBR etc.) and channel quality information such as channel quality indicator (Cal), Rank, signal to interference plus noise ratio (SINR) etc) to make the decisions.

In LTE, the Buffer Status reporting (BSR) procedure is used between the UE and the network to provide the serving eNB with the information about the amount of data available for transmission in the UL buffers of the UE.

In LTE, the Scheduling Request (SR) is used for requesting UL-shared channel (SCH) resources for new transmission. UE's MAC triggers scheduling request when a regular BSR is triggered and UE doesn't have uplink resources for transmission of at least the regular BSR. Regular BSR is triggered when data becomes available for transmission in the uplink.

In LTE, the scheduler uses the BSR and SR from the UE to perform scheduling. When the scheduler has decided to schedule a UE in the uplink, it sends an uplink grant to the UE. The uplink grant indicates which radio resources, physical radio blocks (PRB) and modulation and coding scheme (MCS), to be used by the UE in its uplink transmission in a specific transmission time interval (TTI).

A LTE scheduler performs following function for efficient scheduling:
Link Adaptation: It selects the optimal combination of parameters such as modulation, channel Coding & transmit schemes i.e. Transmission Mode such as TM1/TM2/TM3/TM4, as a function of the radio frequency (RF) conditions.
Rate Control: It is in charge of resource allocation among radio bearers of the same UE which are available at the eNB for DL and at the UE for UL.
Packet Scheduler: It arbitrates access to air interface resources on 1 ms-TTI basis amongst all active Users, Users in RRC Connected State.
Resource Assignment: It allocates air interface resources to selected active users on per TTI basis.
Power Control: Provides the desired SINR level for achieving the desired data rate, but also controls the interference to the neighbouring cells.
Hybrid automatic repeat request (HARQ) such as automatic repeat request (ARQ)+forward error correction (FEC): It allows recovering from residual errors by link adaptation.

The principles for scheduling in NR is similar to the principle in LTE described above. In case of central unit (CU)—distributed unit (DU) split, the scheduler is hosted in the gNB-DU entity.

Functional Split Case of CU/DU Split

An access node, such as an NG-RAN node or a gNB, can be split in 2 logical entities, namely gNB-CU and gNB-DU. The interface between these 2 nodes is called F1. Examples of handover procedures involving these network nodes can be found in 3GPP TS 38.401 v.15.4.0. The messages exchanged on the F1 interface during these procedures are defined in TS 38.473 v.15.4.0.

Encryption and decryption of RRC messages is done by the gNB-CU. Information about protected RRC messages can be found in 3GPP TS 38.331 v.15.4.0, Annex B.

Scheduling is done by the gNB-DU.

When setting up the user plane entities in an access node, such as when establishing or resuming the RRC connection, or after handover, the access node needs to assume the worst-case radio conditions, for example, that the UE has the worst-case link budget, when scheduling the UE.

Then it takes some time before actual knowledge exists in the access node and control loops have been adjusted to an optimal working point. Therefore, it will be a delay before having established an optimized data flow with high bitrate and/or minimal loss of packets.

For handover, this delay may even cause a disturbance in user data flow, which results in delay jitter which may end up in e.g. a “jerky” video or voice dropouts, for video or voice services. In particular, services that require a steady flow of packets and sometimes also a low latency, such as industrial internet of things (IIoT) and Ultra Reliable Low Latency Communications (URLLC), are affected after handover.

### SUMMARY

An object herein is to provide a mechanism to in an efficient manner enable communication in a wireless communication network.

According to an aspect the object is achieved, according to embodiments herein, by providing a method performed by a user equipment (UE) for handling establishment of a connection of the UE in a wireless communication network. The UE may be connected and served by a radio network node. The UE obtains information also referred to as scheduling assistance information such as transmission data such as QoS data, CSI report, amount of data, for the UE. The UE then transmits the information e.g. an indication of the obtained scheduling assistance information to an access node e.g. in a message to the radio network node. The indication is added in a message from the UE transmitted to the access node for establishing the connection of the UE. This may be performed at a scenario relating to establishment of connection such as handover, reestablishment, resuming or resynching.

According to another aspect the object is achieved, according to embodiments herein, by providing a method performed by a radio network node, also referred to as access node, for, enabling or handling communication i.e. handling establishment of a connection of a UE in a wireless communication network. The radio network node may be serving the UE and another radio network node may also serve the UE. The radio network node receives a message for establishing the connection of the UE, wherein the message comprises an indication of scheduling assistance information for the UE from the UE and performs an operation, e.g. scheduling, associated with scheduling of the UE based on the received indication. This may be performed at a scenario relating to establishment of connection such as handover, reestablishment, resuming or resynching.

It is furthermore provided herein a computer program product comprising instructions, which, when executed on at least one processor, cause the at least one processor to carry out any of the methods above, as performed by the UE and the access node, respectively. It is additionally provided herein a computer-readable storage medium, having stored thereon a computer program product comprising instructions which, when executed on at least one processor, cause the at least one processor to carry out the method according to any of the methods above, as performed by the UE and the access node, respectively.

According to embodiments herein a UE is herein provided for handling establishment of a connection of the UE in a wireless communication network. The UE is configured to obtain scheduling assistance information for the UE; and to transmit to an access node, an indication of the obtained scheduling assistance information, wherein the indication is added in a message for from the UE to the access node for establishing the connection of the UE.

According to embodiments herein an access node is provided for handling establishment of a connection of a UE in a wireless communication network. The access node is configured to receive a message for establishing the connection of the UE, wherein the message comprises an indication of scheduling assistance information for the UE. The access node is further configured to perform an operation associated with scheduling of the UE based on the received indication.

A solution is to provide relevant scheduling assistance information from the UE to the radio network node as also referred to as the access node. The information may be sent from the UE to the network at occasions for establishing a connection for the UE such as:
At RRC connection establishment
At RRC connection re-establishment
At RRC resume
At Secondary Cell Group (SCG) setup/Secondary node addition
At handover
At Secondary Node change while in EN-DC configuration
At resync due to UL inactivity
At resync due to no response on Scheduling request
At resync due to beam recovery
At request for on demand system information

Examples of scheduling assistance information obtained by the UE may be:
Amount of UL data waiting
UE power used when sending message 3
UE measured SINR on signal used as sync source for random access
CSI report (preconding matrix indicator (PMI), RANK, CQI)
QoS, QoS Class Identifier (QCI), 5G QoS Indicator (5QI) and/or QoS Flow ID (QFI) of pending UL data. Possibly different indications associated with different parts/amounts of the pending UL data.
The radio bearer(s) which will be used for the pending UL data. Possibly, pending UL data amounts could be indicated per radio bearer. This would only be used when radio bearers are configured, i.e. not when the UE establishes RRC or establishes an RRC connection, i.e. when transiting from RRC_IDLE state.
Application(s) in the UE to which the pending UL data pertains, e.g. indicated using the app identifiers registered at App Store and Google Play. Possibly different application indications associated with different parts/amounts of the pending UL data.
Active applications in the UE, e.g. indicated using the app identifiers registered at App Store and Google Play.

This scheduling assistance information may then be used by the access node to perform scheduling of the UE. For example, the access node will be able to estimate UL SINR, DL SINR, Transport block sizes possible to use, and number of times the UE need to be scheduled before its buffer is empty. For example:
No data waiting->scheduling by the access node can wait for a while if radio conditions anyhow are good and there is no lack of resources.
Large amount of data waiting->scheduling could be done without waiting for UE SR and if radio quality estimate is available then the efficiency in radio resources can be kept as high as possible already from start at the same time as maximum amount of resources can be used if there is no lack of resources.
Proper priority can be applied to the UE, based on the scheduling assistance information it provided, if prioritization among different UE's competing for the available UL (or DL) transmission resources is needed

This scheduling assistance information may thus be used by the access node to perform scheduling of the UE.

Compared to the prior art, after, for example connection establishment such as RRC connection (re-)establishment, RRC resume, Secondary node addition or a handover, a UE with a lot of UL or DL data, such as when using a high bitrate service, will experience a less drop of the data rate.

Embodiments herein also utilize the radio resources more efficiently, since when there is no UL or DL data waiting in the UE, the access node does not schedule the UE more than necessary.

More precise and relevant prioritization among UE's may be applied at the scheduling, based on more detailed information about pending UL data, when prioritization among different UE's competing for the available UL (or DL) transmission resources is needed.

### BRIEF DESCRIPTION OF THE DRAWINGS

Embodiments will now be described in more detail in relation to the enclosed drawings, in which:

FIGS. 1-8 show signalling schemes and block diagrams relating to wireless communication;

FIG. 9 is a schematic overview depicting a wireless communication network according to embodiments herein;

FIG. 10 shows a method performed by a UE according to embodiments herein;

FIG. 11 shows a MAC CE containing scheduling assistance information (UE power used when sending message 3)

FIG. 12 shows a MAC CE containing scheduling assistance information (UE measured SINR on signal used as sync source for random access)

FIG. 13 shows a method performed by a radio network node according to embodiments herein;

FIG. 14 shows a combined flowchart and signalling scheme according to embodiments herein;

FIG. 15 is a block diagram depicting a UE according to embodiments herein;

FIG. 16 is a block diagram depicting a radio network node according to embodiments herein;

FIG. 17 shows a telecommunication network connected via an intermediate network to a host computer in accordance with some embodiments;

FIG. 18 shows a host computer communicating via a base station with a user equipment over a partially wireless connection in accordance with some embodiments;

FIG. 19 shows methods implemented in a communication system including a host computer, a base station and a user equipment in accordance with some embodiments;

FIG. 20 shows methods implemented in a communication system including a host computer, a base station and a user equipment in accordance with some embodiments;

FIG. 21 shows methods implemented in a communication system including a host computer, a base station and a user equipment in accordance with some embodiments; and

FIG. 22 shows methods implemented in a communication system including a host computer, a base station and a user equipment in accordance with some embodiments.

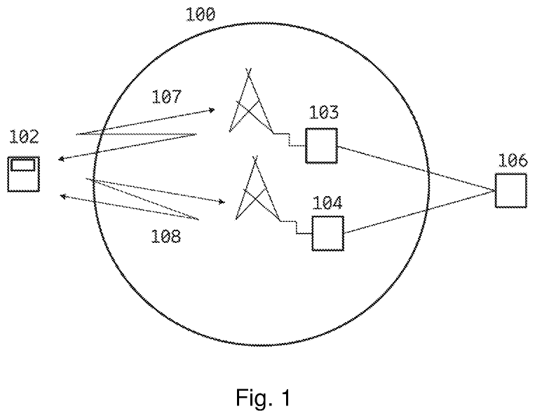

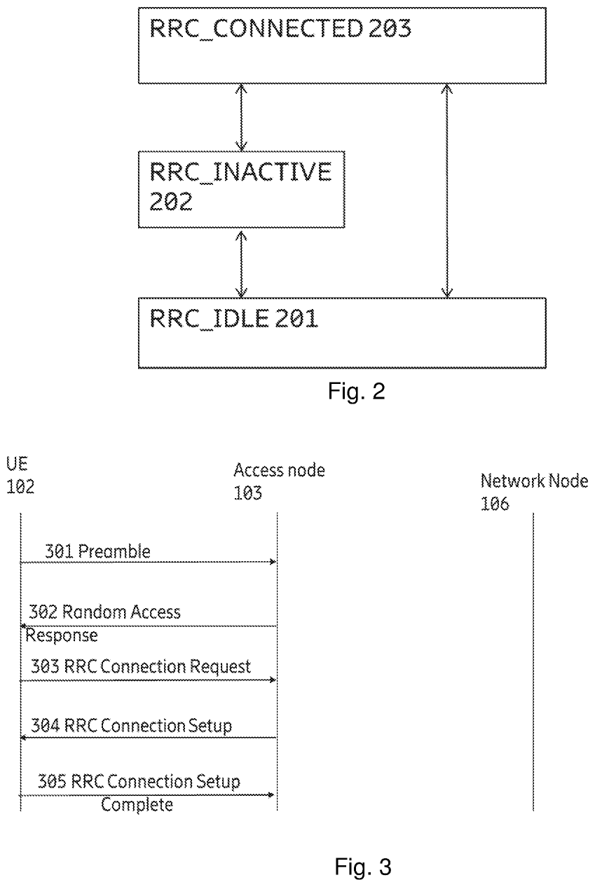

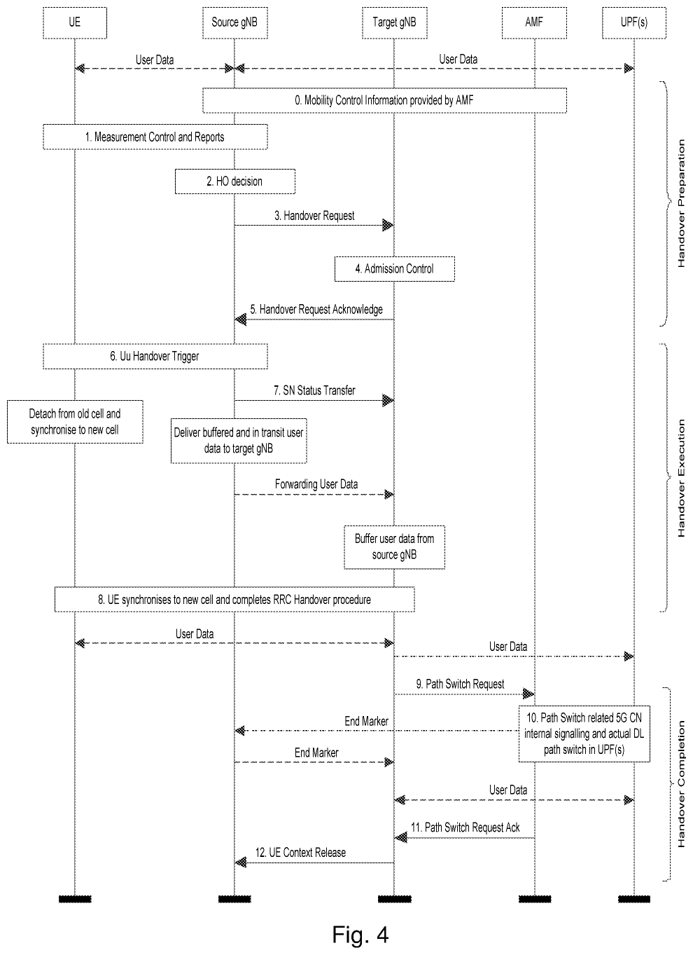

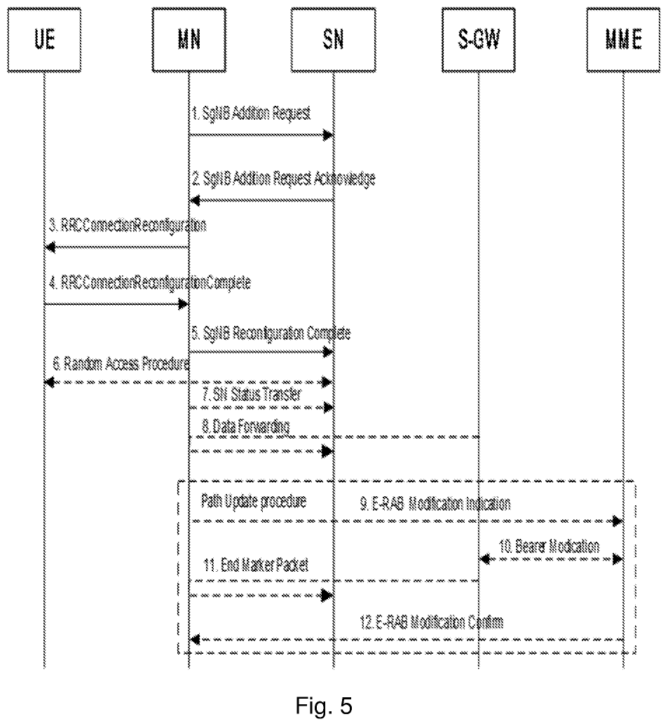

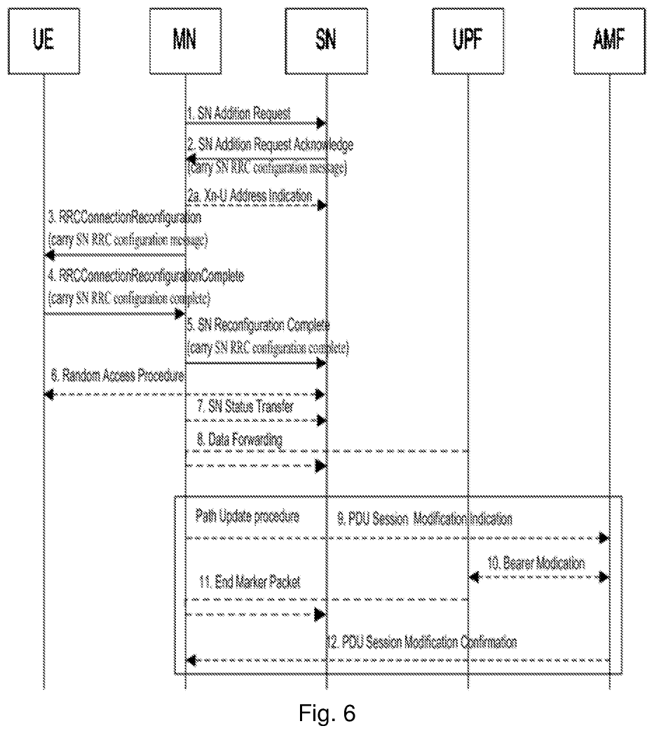

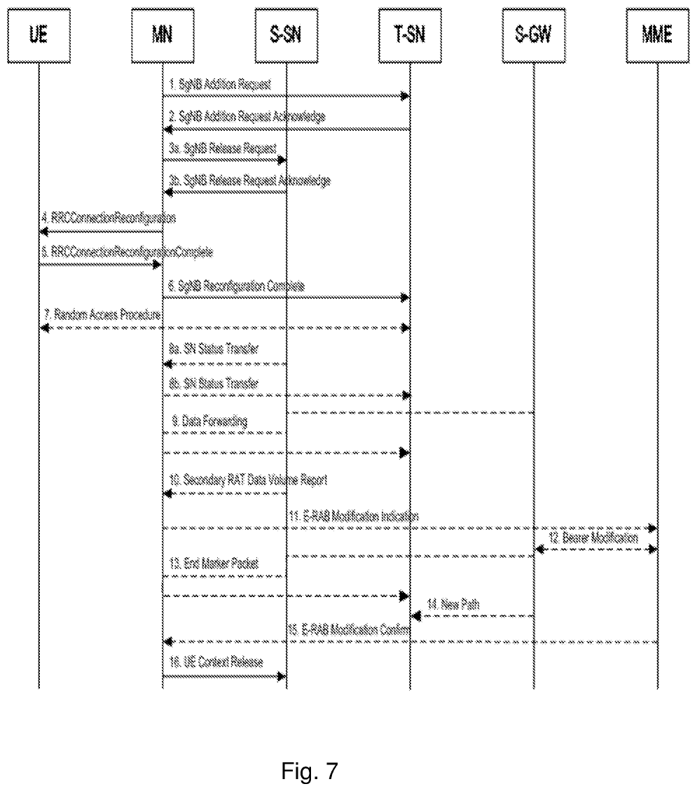

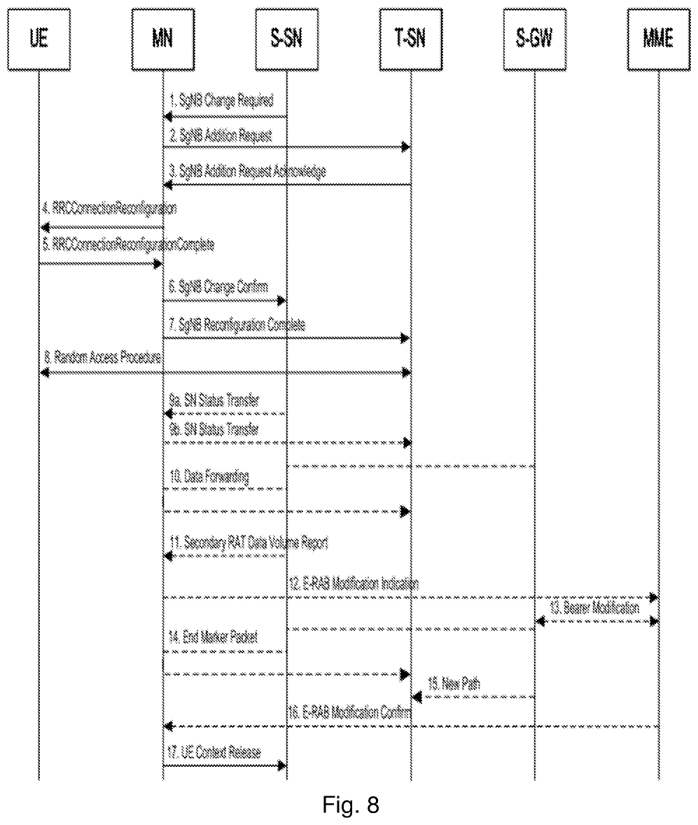

### DETAILED DESCRIPTION

Embodiments herein relate to wireless communication networks in general. FIG. 9 is a schematic overview depicting a wireless communication network 1. The wireless communication network 1 comprises one or more RANs and one or more CNs. The wireless communication network 1 may use one or a number of different technologies. Embodiments herein relate to recent technology trends that are of particular interest in a 5G context, however, embodiments are also applicable in further development of existing wireless communication systems such as e.g. LTE and Wideband Code Division Multiple Access (WCDMA).

In the wireless communication network 1, wireless devices configured to communicate with the RAN e.g. a UE 10, such as a communication device. It should be understood by the skilled in the art that “UE” is a non-limiting term which means any terminal, wireless communication terminal, wireless device, narrowband-internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node or a wireless device.

The wireless communication network 1 comprises a first radio network node 12 also referred to as source access node providing radio coverage over a geographical area, a service area 11, of a first radio access technology (RAT), such as NR, LTE or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the first radio network node 12 depending e.g. on the first radio access technology and terminology used. The first radio network node 12 may be referred to as a serving radio network node such as a source access node wherein the service area may be referred to as a serving cell, and the serving network node communicates with the UEs in form of DL transmissions to the UEs and UL transmissions from the UEs. It should be noted that a service area may be denoted as cell, beam, beam group or similar to define an area of radio coverage. The first radio network node may be serving a cell of a master cell group for the UE 10.

The wireless communication network 1 may further comprise a second radio network node 13 also referred to as target access node providing radio coverage over a geographical area, a second service area 14, of a second radio access technology (RAT), such as NR, LTE or similar. The second radio network node 13 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the second radio network node 13 depending e.g. on the second radio access technology and terminology used. The second radio network node 13 may be referred to as a target access node e.g. a secondary serving radio network node wherein the service area may be referred to as a secondary serving cell, and the secondary serving radio network node communicates with the UEs in form of DL transmissions to the UEs and UL transmissions from the UEs. It should be noted that a service area may be denoted as cell, beam, beam group or similar to define an area of radio coverage. The second radio network node 13 may be serving a cell of a secondary cell group for the UE 10.

According to embodiments herein the UE 10 sends an indication of obtained scheduling assistance information to an access node such as the first or the second radio network node, which scheduling assistance information is used by the access node when scheduling the UE 10. The indication is added in a message from the UE 10 to the access node for establishing the connection of the UE. Embodiments herein relate to sending information for scheduling the UE 10 at certain scenarios or procedures and in certain messages. For example, including the scheduling assistance information such as amount of UL data waiting, in a Msg3 i.e. a message relating to connection establishment, such as an RRCConnectionRequest. The information is thus received earlier by the network than in prior art, which is an advantage.

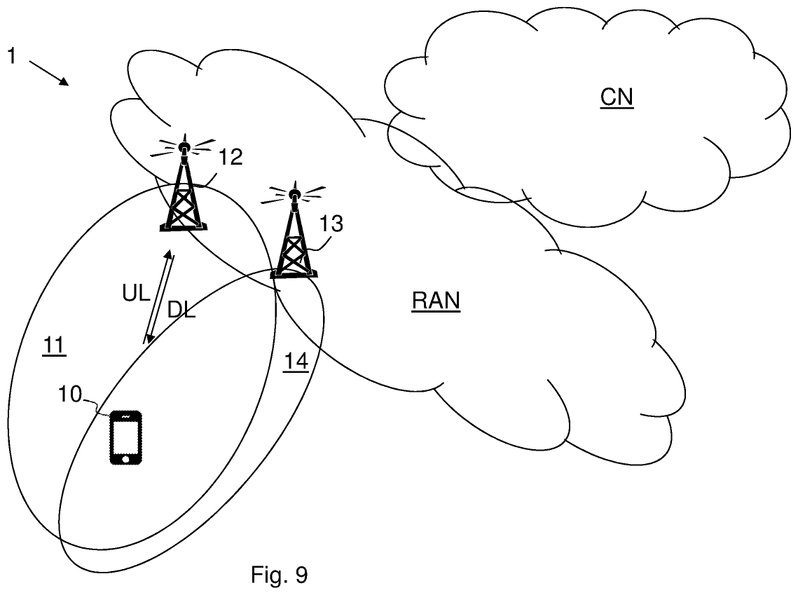

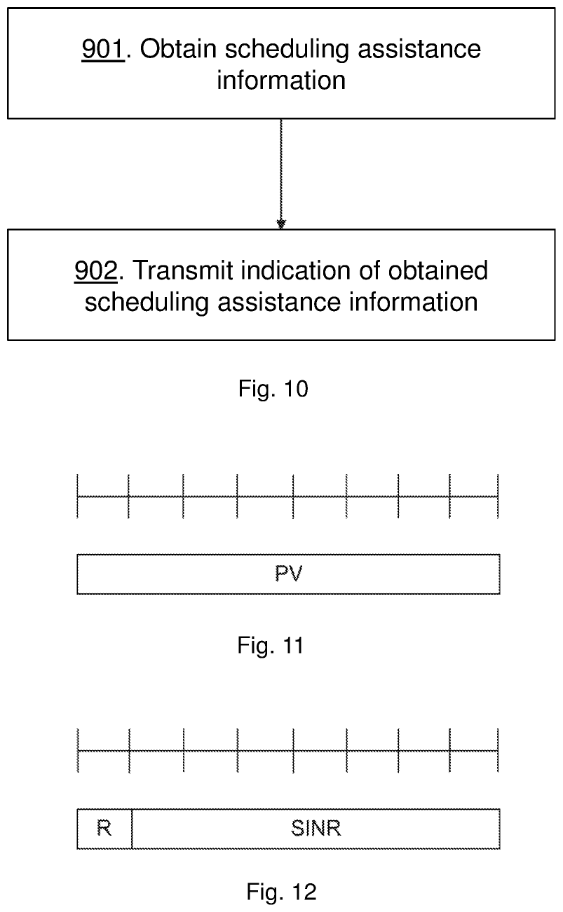

In FIG. 10, some steps, performed by the UE 10, are illustrated method performed by a user equipment, UE, for handling establishment of a connection of the UE in the wireless communication network.

Action 901. The UE 10 obtains scheduling assistance information for the UE 10. The scheduling assistance information may comprise amount of uplink data waiting; UE power used when sending message 3; UE measured SINR on signal used as sync source for random access; CSI report; quality of service (QoS), QoS Class Identifier (QCI), 5G QoS Indicator (5QI), and/or QoS Flow ID (QFI) of pending UL data; which radio bearer that will be used for the pending UL data; application in the UE to which the pending UL data pertains; and/or active application in the UE.

In action 901, the UE 10 obtains scheduling assistance information. In one example, the scheduling assistance information is amount of UL data waiting. In another example, the scheduling assistance information is UE power used when sending message 3. In yet another example, the scheduling assistance information is UE measured SINR on signal used as sync source for random access. In yet another example, the scheduling assistance information is a CSI (Channel Status Information) report (PMI—Precoding Matrix Index, RI—Rank Indicator, CQI—Channel Quality Indicator).

In yet another example, the scheduling assistance information is QoS, QCI, 5QI and/or QFI of pending UL data. In this example, possibly different indications is provided associated with different parts/amounts of the pending UL data. In yet another example, the scheduling assistance information is the radio bearer(s) which will be used for the pending UL data. In this example, possibly pending UL data amounts could be indicated per radio bearer. Typically, this would be used when radio bearers are configured. In yet another example, the scheduling assistance information is identification of application(s) in the UE to which the pending UL data pertains (e.g. indicated using the app identifiers registered at App Store and Google Play). In this example, possibly different type of application indications associated with different parts/amounts of the pending UL data. In yet another example, the scheduling assistance information is identification of active applications in the UE (e.g. indicated using the app identifiers registered at App Store and Google Play).

Action 902. The UE 10 transmits to the access node, an indication of the obtained scheduling assistance information, wherein the indication is added in a message from the UE 10 to the access node for establishing the connection of the UE. The indication may be an index value or values shown underlined in the examples below. The message may be one of the following messages: a random access message; a MAC PDU; a MAC Control Element; an RRCSetupRequest message; an RRCConnectionRequest message; an RRCReestablishmentRequest; an RRCConnectionReestablishmentRequest message; an RRCResumeRequest message; an RRCConnectionResumeRequest; an RRCReconfigurationComplete message; an RRCConnectionReconfigurationComplete message; or a MeasurementReport message. The message may be an RRCResumeRequest message and contains a short inactive Radio Network Temporary Identifier in order to make room for the indication of the obtained scheduling assistance information. The message may be sent: at RRC connection establishment; at RRC connection re-establishment, at RRC resume or RRC connection resume; at Secondary Cell Group setup or Secondary node addition; at handover; at Secondary Node change while in EN-DC configuration; at resync due to UL inactivity; at resync due to no response on Scheduling request; at resync due to beam recovery; or at request for on demand system information.

In action 902, the UE 10 sends a message to the access node such as the first or the second radio network node including the scheduling assistance information. This is performed during or at a connection establishment. In one example, the message is a random access message such as “Msg3” (such as a MAC PDU) when performing a random access at resync due to UL inactivity, at resync due to no response on Scheduling Request or at resync due to beam recovery, due to establishing/re-establishing/resuming the RRC connection, at request for on demand system information, connecting to a secondary node at secondary node addition or connecting to a target access node at handover. When signaled in such a random access Msg3, the scheduling assistance information could be included in a MAC CE or in the MAC PDU payload. If contained in the MAC PDU payload, the scheduling assistance information could be included in the first RRC message transferred from the UE to the network at establishing/re-establishing/resuming the RRC connection, at request for on demand system information, at resync due to UL inactivity, at resync due to no response on Scheduling request or at resync due to beam recovery, such as an RRCSetupRequest message, an RRCReestablishmentRequest message or an RRCResumeRequest message, an RRCResumeRequest1 message or another RRC message such as a MeasurementReport message. In yet another example, the message is the first RRC message transferred from the UE to the network at connecting to a secondary node at secondary node addition, during secondary node change, or connecting to a target access node at handover, such an RRCReconfigurationComplete or an RRCConnectionReconfigurationComplete message. In yet another example, the message is the second RRC message transferred from the UE to the network at establishing/re-establishing/resuming the RRC connection, such as an RRCSetupComplete message, an RRCReestablishmentComplete message, an RRCResumeComplete message or a MeasurementReport message.

If the scheduling assistance information is included in an RRCRequest (or an RRCConnectionRequest) or an RRCResumeRequest (or an RRCConnectionResumeRequest), then the spare bit could be used for this purpose to signal very simple scheduling assistance information, e.g. indicating small or large pending UL data amount (e.g. below a certain threshold amount or equal to or above the threshold amount), where the threshold amount could be specified or configured, e.g. in the system information. Scheduling assistance information could also be indicated in the spare EstablishmenCause value(s) or ResumeCause value(s), e.g. indicating mo-data_with large_data_amount_waiting”, “mo-video_with_large_data_amount_waiting”, etc. Scheduling assistance information in the spare EstablishmenCause value(s) or ResumeCause value(s) could be combined with scheduling assistance information in the spare bit. Different combinations could be used to provide different types of scheduling assistance information.

If the scheduling assistance information is included in a MAC CE, i.e. in random access Msg3 or Msg5, the MAC CE could be a modified Buffer Status Report MAC CE or a new type of Buffer Status Report MAC CE.

An example of a possible implementation of action 902, using a MAC CE containing UE power used when sending message 3 is illustrated in FIG. 11. “PV” is a transmit power level, for example represented as a value between 0-63, such as the P_{CMAX,f,c} as specified in 3GPP TS 38.213 v.15.4.0, or a output power value (PV) measured in dBm in some range, e.g. between −202 and 24 dBm.

An example of a possible implementation of step 902, using a MAC CE containing UE measured SINR on signal used as sync source for random access is illustrated in FIG. 12. “R” is a reserved bit. “SINR” is a measured Signal to Interference plus Noise Ratio, for example represented as a value between 0-127 as defined in 3GPP TS 38.133.

An example of a possible implementation of action 902, when the message is the first message transferred from the UE to the network at RRC connection establishment, for example the RRCSetupComplete message in NR, is illustrated below, where a SchedulingAssistanceInfo IE is included, which may in turn include amount of uplink data waiting, UE power used when sending message 3, UE measured SINR on signal used as sync source for random access or a CSI report.

RRCSetupComplete

The RRCSetupComplete message is used to confirm the successful completion of an RRC connection establishment.

Signalling radio bearer: SRB1

RLC-SAP: AM

Logical channel: DCCH

Direction: UE to Network

RRCSetupComplete message

-- ASN1START
-- TAG-RRCSETUPCOMPLETE-START

| | |
|---|---|
| RRCSetupComplete ::= | SEQUENCE { |
| rrc-TransactionIdentifier | RRC-TransactionIdentifier, |
| criticalExtensions | CHOICE { |
| rrcSetupComplete | RRCSetupComplete-IEs, |
| criticalExtensionsFuture | SEQUENCE { } |

}
}

| | |
|---|---|
| RRCSetupComplete-IEs ::= | SEQUENCE { |
| selectedPLMN-Identity | INTEGER (1..maxPLMN), |
| registeredAMF | RegisteredAMF |

OPTIONAL,

| | |
|---|---|
| guami-Type | ENUMERATED {native, mapped} |

OPTIONAL,

| | |
|---|---|
| s-nssai-List | SEQUENCE (SIZE (1..maxNrofS-NSSAI)) OF S-NSSAI |

OPTIONAL,

| | |
|---|---|
| dedicatedNAS-Message | DedicatedNAS-Message, |
| ng-5G-S-TMSI-Value | CHOICE { |
| ng-5G-S-TMSI | NG-5G-S-TMSI, |
| ng-5G-S-TMSI-Part2 | BIT STRING (SIZE (9)) |

}
OPTIONAL,

| | |
|---|---|
| lateNonCriticalExtension | OCTET STRING |

OPTIONAL,

| | |
|---|---|
| nonCriticalExtension | RRCSetupComplete-v1600-IEs |

OPTIONAL
}

| | |
|---|---|
| RRCSetupComplete-v1600-IEs ::= | SEQUENCE { |
| schedulingAssistanceInfo | SchedulingAssistanceInfo OPTIONAL, |
| nonCriticalExtension | SEQUENCE{ } |

OPTIONAL
}

| | |
|---|---|
| RegisteredAMF ::= | SEQUENCE { |
| plmn-Identity | PLMN-Identity |

OPTIONAL,

| | |
|---|---|
| amf-Identifier | AMF-Identifier |

}
SchedulingAssistanceInfo ::= SEQUENCE {

| | |
|---|---|
| ulDataWaiting | SEQUENCE(SIZE (1..8)) OF BufferSizePerLCG OPTIONAL, |
| msg3Power | INTEGER (−202..24) OPTIONAL, |
| ssSinr | INTEGER (0..127) OPTIONAL, |
| csiReport | BIT STRING OPTIONAL |

} OPTIONAL
}
SchedulingAssistanceInfo field descriptions
ulDataWaiting
Locial channel group identity
msg3Power
UE power used when sending message 3
ssSinr
UE measured SINR on signal used as sync source for random access as defined in TS 38.133
csiReport
Channel State Information according to 3GPP TS 38.214.
BufferSizePerLCG ::= SEQUENCE {

| | |
|---|---|
| lcgID | INTEGER (0..7), |
| ulBufferSize | INTEGER (0..255) |

}
BufferSizePerLCG field descriptions
lcgID
Locial channel group identity
ulBufferSize
UL data level as specified in 38.321 Buffer size level for 8-bit buffer size
-- TAG-RRCSETUPCOMPLETE-STOP
-- ASN1STOP

A similar method to include the SchedulingAssistanceInfo information element above in the RRCSetupComplete message, may be used to include it in other RRC messages, such as RRCReestablishmentComplete, RRCResumeComplete or MeasurementReport.

An example of a possible implementation of action 902, when the message is the first RRC message transferred from the UE 10 to the network at RRC connection resume, is illustrated below. In this example, a new type of message is used, an RRCResumeRequest2 message, where a SchedulingAssistanceInfo IE is included, which may in turn include amount of uplink data waiting, UE power used when sending message 3, UE measured SINR on signal used as sync source for random access or a CSI report. In one alternative the RRCResumeRequest2 message contains a short-I-RNTI in order to make room for the SchedulingAssistanceInfo. In another alternative, a message RRCResumeRequest3 is defined also, which is similar to the RRCResumeRequest2 below, but contains the I-RNTI instead of the short-I-RNTI. The same definition for the SchedulingAssistanceInfo as for the RRCSetupComplete in the example above may be used. If a shorter variant of the SchedulingAssistanceInfo is required (to meet a size constraint for example), one or multiple fields from the SchedulingAssistanceInfo may need to be omitted, such as the CSI report.

In this example, as there are multiple types of the first RRC message transferred from the UE to the network at RRC connection resume (such as RRCResumeRequest, RRCResumeRequest1, RRCResumeRequest2 and RRCResumeRequest3), there may be standardized rules on which message to send to the network, or the network may indicate in an instruction, e.g. in system information, which type of message to send. As one example of a standardized rule, if the grant size provided by the access node to the UE for transmission of the message is larger than a given threshold, the UE uses a given message. For example, if the grant size is at least N bits, the UE uses RRCResumeRequest3, and if the grant size is below N bits, the UE uses RRCResumeRequest2. As another example of a standardized rule, the available fields in the SchedulingAssistanceInfo IE is included in a specified priority order until the UE cannot fit more fields in the granted size.

RRCResumeRequest2

The RRCResumeRequest2 is a message used to request the resumption of a suspended RRC connection or perform an RNA update.

Signalling radio bearer: SRB0

RLC-SAP: TM

Logical channel: CCCH1

Direction: UE to Network

### RRCResumeRequest2 Message

| -- ASN1START | |
|---|---|
| -- TAG-RRCRESUMEREQUEST2-START | |
| RRCResumeRequest2 ::= SEQUENCE { | |
| rrcResumeRequest2 | RRCResumeRequest2-IEs |
| } | |
| RRCResumeRequest2-IEs ::= | SEQUENCE { |
| resumeIdentity | ShortI-I-RNTI-Value, |
| resumeMAC-I | BIT STRING (SIZE (16)), |
| resumeCause | ResumeCause, |
| schedulingAssistanceInfo | SchedulingAssistanceInfo OPTIONAL, |

}
-- TAG-RRCRESUMEREQUEST2-STOP
-- ASN1STOP

An example of a possible implementation of action 902, when the message is the first RRC message transferred from the UE 10 to the network at RRC connection establishment is illustrated below. In this example, a new type of message is used, the RRCSetupRequest1 message, where a SchedulingAssistanceInfo IE is included, which may in turn include amount of uplink data waiting, UE power used when sending message 3, UE measured SINR on signal used as sync source for random access or a CSI report. This RRCSetupRequest1 message is typically larger than the RRCSetupRequest message. The same definition for the SchedulingAssistanceInfo as for the RRCSetupComplete in the example above may be used. If a shorter variant of the SchedulingAssistanceInfo is required (to meet a size constraint example), one or multiple fields from the SchedulingAssistanceInfo may need to be omitted, such as the CSI report.

In this example, as there are multiple types of the first RRC message transferred from the UE to the network at RRC connection establishment (RRCSetupRequest and RRCSetupRequest1), there may be standardized rules on which message to send to the network, or the network may indicate in an instruction, e.g. in system information, which type of message to send. As one example of a standardized rule, if the grant size provided by the access node to the UE for transmission of the message is larger than a given threshold, the UE uses a given message. For example, if the grant size is at least N bits, the UE uses RRCSetupRequest1, and if the grant size is below N bits, the UE uses RRCSetupRequest. As another example of a standardized rule, the available fields in the SchedulingAssistanceInfo IE is included in a specified priority order until the UE cannot fit more fields in the granted size.

RRCSetupRequest1

The RRCSetupRequest1 message is used to request the establishment of an RRC connection.

Signalling radio bearer: SRB0

RLC-SAP: TM

Logical channel: CCCH

Direction: UE to Network

RRCSetupRequest1 message

-- ASN1START
-- TAG-RRCSETUPREQUEST1-START

| | |
|---|---|
| RRCSetupRequest1 ::= | SEQUENCE { |
| rrcSetupRequest1 | RRCSetupRequest1-IEs |

}

| | |
|---|---|
| RRCSetupRequest1-IEs ::= | SEQUENCE { |
| ue-Identity | InitialUE-Identity, |
| establishmentCause | EstablishmentCause, |
| schedulingAssistanceInfo | SchedulingAssistanceInfo OPTIONAL, |

}

| | |
|---|---|
| InitialUE-Identity ::= | CHOICE { |
| ng-5G-S-TMSI-Part1 | BIT STRING (SIZE (39)), |
| randomValue | BIT STRING (SIZE (39)) |

}

| | |
|---|---|
| EstablishmentCause ::= | ENUMERATED { |
| | emergency, highPriorityAccess, mt-Access, mo- |

Signalling,

mo-Data, mo-VoiceCall, mo-VideoCall, mo-SMS, mps-

PriorityAccess, mcs-PriorityAccess,

spare6, spare5, spare4, spare3, spare2, spare1}

-- TAG-RRCSETUPREQUEST1-STOP
-- ASN1STOP

An example of a possible implementation of action 902, when the message is the first RRC message transferred from the UE 10 to the network at request of on demand system information is illustrated below. In this example, a new type of message is used, the RRCSystemInfoRequest1 message, where a SchedulingAssistanceInfo IE is included, which may in turn include amount of uplink data waiting, UE power used when sending message 3, UE measured SINR on signal used as sync source for random access or a CSI report. This RRCSystemInfoRequest1 message is typically larger than the RRCSystemInfoRequest message. The same definition for the SchedulingAssistanceInfo as for the RRCSetupComplete in the example above may be used. If a shorter variant of the SchedulingAssistanceInfo is required (to meet a size constraint example), one or multiple fields from the SchedulingAssistanceInfo may need to be omitted, such as the CSI report.

RRCSystemInfoRequest1

The RRCSystemInfoRequest1 message is used to request SI message(s) required by the UE as specified in section 5.2.2.3.3.

Signalling radio bearer: SRB0

### RLC-SAP: TM

Logical channel: CCCH

### Direction: UE to Network

### RRCSystemInfoRequest1 Message

-- ASN1START
-- TAG-RRCSYSTEMINFOREQUEST1-START

| | |
|---|---|
| RRCSystemInfoRequest1 ::= | SEQUENCE { |
| criticalExtensions | CHOICE { |
| rrcSystemInfoRequest1-r15 | RRCSystemInfoRequest1-r15-IEs, |
| criticalExtensionsFuture | SEQUENCE { } |
| } | |
| } | |
| RRCSystemInfoRequest1-r15-IEs ::= | SEQUENCE { |
| requested-SI-List | BIT STRING (SIZE (maxSI-Message)), --32bits |
| schedulingAssistanceInfo | SchedulingAssistanceInfo OPTIONAL, |

}
-- TAG-RRCSYSTEMINFOREQUEST1-STOP
-- ASN1STOP

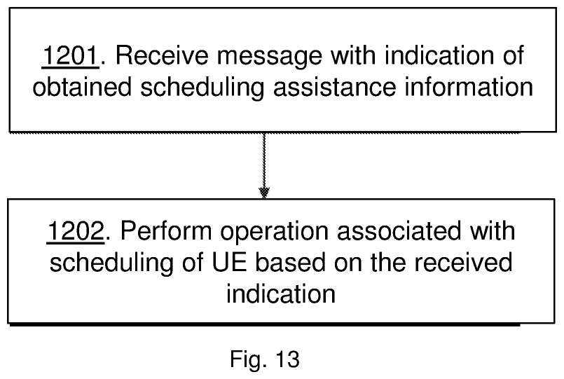

In FIG. 13, some actions, performed by the access node such as the radio network node 12, are illustrated for handling establishment of the connection of the UE 10 in the wireless communication network.

Action 1201. The access node receives the message for establishing the connection of the UE, wherein the message comprises the indication of scheduling assistance information for the UE 10. The message may be one of the following messages: a random access message; a MAC PDU; a MAC Control Element; an RRCSetupRequest message; an RRCConnectionRequest message; an RRCReestablishmentRequest; an RRCConnectionReestablishmentRequest message; an RRCResumeRequest message; an RRCConnectionResumeRequest; an RRCReconfigurationComplete message; an RRCConnectionReconfigurationComplete message; or a MeasurementReport message. The message may be sent: at RRC connection establishment; at RRC connection re-establishment, at RRC resume or RRC connection resume; at Secondary Cell Group setup or Secondary node addition; at handover; at Secondary Node change while in EN-DC configuration; at resync due to UL inactivity; at resync due to no response on Scheduling request; at resync due to beam recovery; or at request for on demand system information. The scheduling assistance information may be one of, or both of information obtained by a source radio network node, and information obtained by the UE 10. The scheduling assistance information may comprise amount of uplink data waiting; UE power used when sending message 3; UE measured SINR on signal used as sync source for random access; CSI report; QoS, QCI, 5QI, and/or QFI, of pending UL data; which radio bearer that will be used for the pending UL data; application in the UE to which the pending UL data pertains; and/or active application in the UE. The message may be an RRCResumeRequest message and may contain a short inactive Radio Network Temporary Identifier in order to make room for the indication of the obtained scheduling assistance information. The access node may be a distributed node comprising a central unit and a distributed unit, and wherein encrypted RRC messages are decrypted in the central unit and the scheduling assistance information is sent to the distributed unit.

In action 1201, e.g. the radio network node 12 receives a message from the UE 10 including scheduling assistance information.

In case of CU/DU split, encrypted RRC messages (such as RRCSetupComplete) are deciphered in gNB-CU and any scheduling assistance information is sent to gNB-DU. On the other hand, unencrypted RRC messages can be decoded in the gNB-DU. For examples, such unencrypted messages are the first RRC message transferred from the UE 10 to the network at establishing/re-establishing/resuming the RRC connection or at request for on demand system information, such as the RRCSetupRequest message, the RRCReestablishmentRequest message, the RRCResumeRequest message, the RRCResumeRequest1 message, the RRCSystemInfoRequest1 message or other messages sent on what is known as Signalling Radio Bearer 0 (SRB0). In this case, the gNB-DU may obtain the Scheduling Assistance Information in the received unencrypted message from the UE 10. Whether the Scheduling Assistance Information can be included in the first RRC message (Msg3) depends on the size of the grant provided by the network (gNB-DU).

In one example, the scheduling assistance information is amount of UL data waiting. In another example, the scheduling assistance information is UE power used when sending message 3. In yet another example, the scheduling assistance information is UE measured SINR on signal used as sync source for random access. In yet another example, the scheduling assistance information is a CSI report (PMI, RANK, Cal). The message thus contains scheduling assistance information.

Action 1202. The access node performs an operation associated with scheduling of the UE 10 based on the received indication. The access node may be a target radio network node of the handover, and the access node may perform the operation by performing opportunistic scheduling of the UE after the handover using the indicated scheduling assistance information. Performing opportunistic scheduling may comprise using a criterion to determine whether to use opportunistic scheduling or not. The criterion to determine whether to use opportunistic scheduling or not may be based on the indicated scheduling assistance information. Opportunistic scheduling differs from regular scheduling in that not waiting for a scheduling request (or a buffer status report) from the UE 10. Furthermore, the access node may perform prioritizations between UEs during scheduling of uplink transmission resources for the UEs.

In action 1202, the access node such as the first radio network node 12 or the second radio network node 13 uses the scheduling assistance information to perform scheduling of the UE 10. Using the scheduling assistance information, the radio network node 12 or the second radio network node 13 will be able to accurately allocate radio resources and schedule the UE 10 after the handover. For example, the access node will be able to estimate UL SINR, DL SINR, Transport block sizes possible to use, and number of times the UE 10 need to be scheduled before buffer is empty.

In one example, the scheduling assistance information is the amount of data waiting (e.g. number of bytes) for the uplink. In this example, the access node schedules the UE in the uplink, by providing enough uplink grants which can carry the amount of UL data waiting received in the scheduling assistance information.

In action 1201, in case of CU/DU split, scheduling information obtained by the gNB-CU, such as from an encrypted RRC message, may be sent from the gNB-CU to the gNB-DU in a new F1AP message or added in existing message, for example UE CONTEXT MODIFICATION REQUEST. Example of new message

### 9.2.x UE Scheduling Assistance Information

### 9.2.x.1 UE SCHEDULING ASSISTANCE INFORMATION

This message is sent by the gNB-CU to provide gNB-DU with scheduling assistance information.

Direction: gNB-CU→gNB-DU.

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| gNB-CU UE | M | | 9.3.1.4 | | YES | reject |
| F1AP ID | | | | | | |
| gNB-DU UE | M | | 9.3.1.5 | | YES | reject |
| F1AP ID | | | | | | |
| UE scheduling | M | | OCTET | Includes the | YES | reject |
| assistance | | | STRING | schedulingAssistanceInfo | | |
| information | | | | IE as defined in subclause | | |
| | | | | 6.3.2 of TS 38.331 [x]. | | |

In action 1202, in case of CU/DU split, the gNB-DU uses the scheduling assistance information to perform scheduling of the UE 10. In case the Scheduling Assistance Information was obtained from a received unencrypted message by the gNB-DU, the gNB-DU will be able to schedule the UE 10 using the Scheduling Assistance Information without involving the gNB-CU.

In one example, the access node such as the first or the second radio network node provides instructions to the UE 10 on which type of scheduling assistance information to be sent to the access node, for example amount of UL data waiting, UE power used when sending random access Msg3, UE measured SINR on signal used as sync source for random access, or a CSI report (PMI, RANK, CQI). The UE 10 then includes the type of scheduling assistance information as instructed by the network.

In another example, the access node provides instructions to the UE 10 on when to send scheduling assistance information to the access node, or in which message to send the information, for example in a Msg3 at random access, in the RRCSetupRequest message, in the RRCReestablishmentRequest message, in the RRCResumeRequest message, in the RRCSetupComplete message, in the RRCReestablishmentComplete message or in the RRCResumeComplete message. The UE 10 then includes the scheduling assistance information in the message as instructed by the access node.

In yet another example, the above instructions from the access node is provided by system information broadcast to the UE 10. In yet another example, the above instructions from the access node is provided by a dedicated message, such as a msg4 at random access, an RRCReconfiguration message, an RRCSetup message, an RRCReestablishment message or an RRCResume message. For instance, the instruction could be included in a HandoverCommand prepared by a target access node (where the HandoverCommand contains RRC configurations to be applied by the UE in the target cell).

In yet another example, in cases there are multiple types of RRC message transferred from the UE 10 to the network, such as at RRC connection establishment (RRCSetupRequest and RRCSetupRequest2) and at RRC connection resume (RRCResumeRequest, RRCResumeRequest1 and RRCResumeRequest2), the above instruction may indicate which type of message to send.

In yet another example, the above instruction may indicate which field(s) to include in the SchedulingAssistanceInfo IE. In this example, the above instruction may include a set of elements of type Boolean. Each element is associated with a field in the SchedulingAssistanceInfo and indicates whether to include that particular field.

In another example, the above instruction contains a CSI report configuration (for example the CSI-ReportConfig IE specified in TS 38.331 v.15.4.0, possibly with an additional reportConfigType CHOICE defined as e.g. “Scheduling Assistance Information”), which configures the Channel Status Information report in the csiReport field in the SchedulingAssistanceInfo IE.

In one example, the access node uses a criterion whether to use opportunistic scheduling or normal scheduling of the UE 10. The criterion may be based on the received scheduling assistance information from the UE 10 in action 1201 or information available in the access node, or a combination of both. In one example, the criterion for opportunistic scheduling is fulfilled when the amount of data waiting (e.g. number of bytes) for the uplink is above a certain threshold. In another example, the criterion for opportunistic scheduling is fulfilled when the amount of data waiting in the downlink is above a certain threshold. In yet another example, the criterion for opportunistic scheduling is fulfilled when the type of handover is a RACH-less handover. In yet another example, the criterion for opportunistic scheduling is fulfilled when a combination two or more of the above criteria is fulfilled, such as the amount of data waiting (e.g. number of bytes) for the uplink is above a certain threshold and the type of handover is a RACH-less handover.

If the criterion for opportunistic scheduling is fulfilled, the access node uses the scheduling assistance information received in action 1201, when scheduling the UE 10 after the handover.

Using the scheduling assistance information, the access node will be able to accurately allocate radio resources and schedule the UE 10 after the handover in action 1202. For example, the access node 10 will be able to estimate UL SINR, DL SINR, Transport block sizes possible to use, and number of times the UE need to be scheduled before buffer is empty. And for example, when the scheduling assistance information is the amount of data waiting (e.g. number of bytes) for the uplink, the access node schedules the UE 10 in the uplink, by providing enough uplink grants which can carry the amount of UL data waiting received in the scheduling assistance information.

If the criterion for opportunistic scheduling is not fulfilled, the access node may wait for a scheduling request (or a buffer status report) from the UE 10, defined here as normal scheduling. When the access node has received a scheduling request (or a buffer status report) from the UE 10, it schedules the UE 10 in the uplink, using the normal scheduling, by providing enough uplink grants which can carry the amount of UL data as indicated in the received scheduling request or buffer status report from the UE 10.

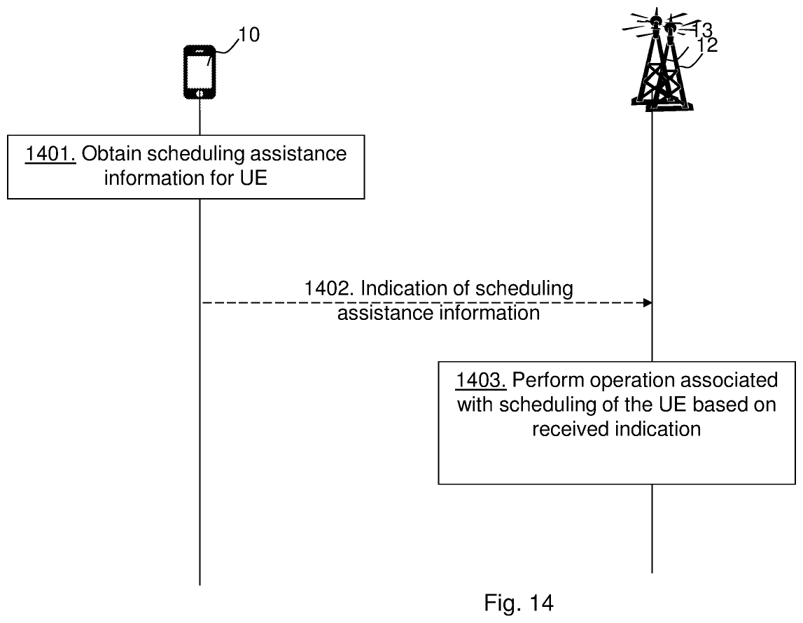

FIG. 14 is a combined signalling scheme and flowchart according to embodiments herein. The first radio network node 12 and7or the second radio network node is configured to serve UEs and may perform handover of the UE 10 to one another e.g. based on received measurement reports from the UE 10.

Action 1401. The UE 10 obtains information also referred to as scheduling assistance information such as transmission data such as QoS data, CSI, amount of data, for the UE 10. The information may comprise amount of uplink data waiting; UE power used when sending message 3; UE measured SINR on signal used as sync source for random access; and/or CSI report.

Action 1402. The UE 10 then transmits the information or an indication of the information to the radio network node e.g. in a message to the radio network node, with the information, for the UE, added. The message may comprise the message is one of the following messages: random access message; MAC PDU; a MAC Control Element; an RRCConnectionRequest message; An RRCConnectionReestablishmentRequest message; An RRCResumeRequest message; An RRCReconfigurationComplete message; MeasurementReport message. This may be performed during or at a connection establishment.

Action 1403. The access node such as the second radio network node 13 or the first radio network node 12 receives the indication of the scheduling assistance information for the UE and performs an operation e.g. scheduling associated with scheduling of the UE 10 based on the received indication. E.g. the second radio network node 13 may use the scheduling assistance information when to perform opportunistic scheduling of the UE after the handover. The scheduling assistance information may be one of, or both information obtained by the first radio network node 12, and information obtained by the UE 10. The access node may use a criterion to determine whether to use opportunistic scheduling, e.g. the criterion to determine whether to use opportunistic scheduling is based on the scheduling assistance information. The second radio network node 13 may use a criterion to determine whether to use opportunistic scheduling or not. Thus, the criterion to determine whether to use opportunistic scheduling or not is based on the received scheduling assistance information. When the radio network node is a distributed node comprising a central unit and a distributed unit encrypted RRC messages may be decrypted in e.g. gNB-CU and scheduling assistance information is sent to gNB-DU.

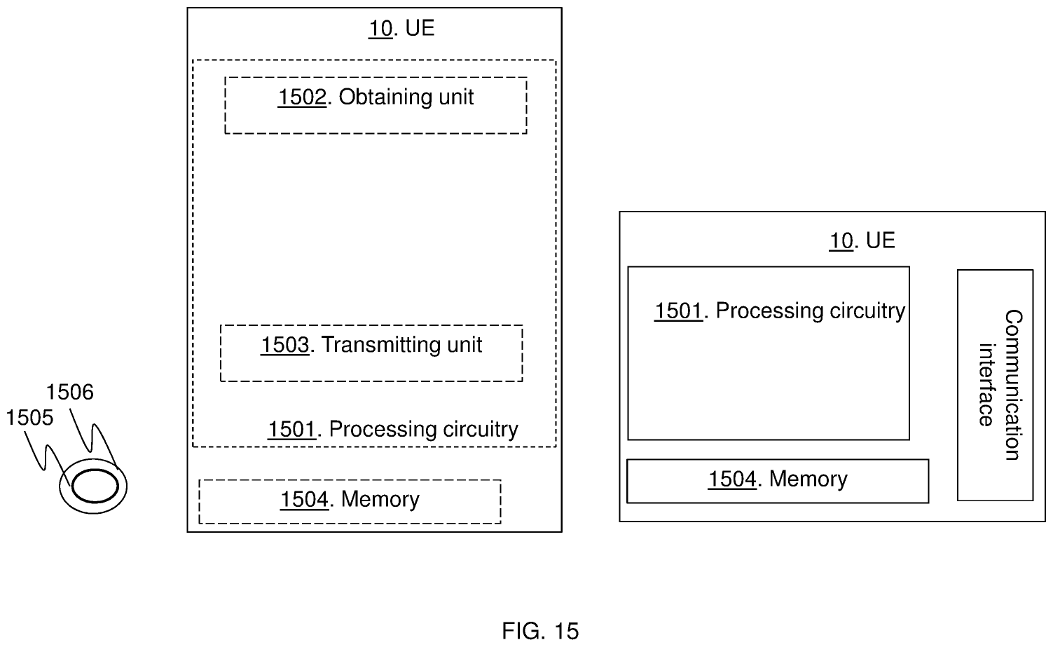

FIG. 15 is a block diagram depicting the UE 10 for handling establishment of a connection of the UE in the wireless communication network according to embodiments herein.

The UE 10 may comprise processing circuitry 1501, e.g. one or more processors, configured to perform the methods herein.

The UE 10 may comprise an obtaining unit 1502, e.g. receiver, a measurer, determiner, scheduler, a transceiver or similar. The UE 10, the processing circuitry 1501, and/or the obtaining unit 1502 is configured to obtain information also referred to as scheduling assistance information such as transmission data such as QoS data, CSI, amount of data, for the UE 10. The information may comprise amount of uplink data waiting; UE power used when sending message 3; UE measured SINR on signal used as sync source for random access; and/or CSI report. The scheduling assistance information may comprise amount of uplink data waiting; UE power used when sending message 3; UE measured SINR on signal used as sync source for random access; CSI report; QoS, QCI, 5QI, and/or QFI, of pending UL data; which radio bearer that will be used for the pending UL data; application in the UE to which the pending UL data pertains; and/or active application in the UE.

The UE 10 may comprise a transmitting unit 1503, e.g. transmitter, determiner, a transceiver or similar. The UE 10, the processing circuitry 1501, and/or the transmitting unit 1503 is configured to transmit to the access node the indication or the information as such of the scheduling assistance information to the access node such as the second radio network node 13 or the first radio network node 12. The indication is added in the message from the UE 10 to the access node for establishing the connection of the UE. This may be performed during or at a connection establishment. The message may be one of the following messages: a random access message; a MAC, protocol data unit PDU; a MAC Control Element; an RRCSetupRequest message; an RRCConnectionRequest message; an RRCReestablishmentRequest; an RRCConnectionReestablishmentRequest message; an RRCResumeRequest message; an RRCConnectionResumeRequest; an RRCReconfigurationComplete message; an RRCConnectionReconfigurationComplete message; or a MeasurementReport message. The message may be sent: at RRC connection establishment; at RRC connection re-establishment, at RRC resume or RRC connection resume; at Secondary Cell Group setup or Secondary node addition; at handover; at Secondary Node change while in EN-DC configuration; at resync due to UL inactivity; at resync due to no response on Scheduling request; at resync due to beam recovery; or at request for on demand system information. The message may be an RRCResumeRequest message and may contain a short inactive Radio Network Temporary Identifier in order to make room for the indication of the obtained scheduling assistance information.

The UE 10 further comprises a memory 1504. The memory comprises one or more units to be used to store data on, such as assistance information, indications, measurements, radio network node IDs, applications to perform the methods disclosed herein when being executed, and similar. The UE 10 may comprise a communication interface e.g. one or more antennas.

The methods according to the embodiments described herein for the UE 10 are respectively implemented by means of e.g. a computer program product 1505 or a computer program, comprising instructions, i.e., software code portions, which, when executed on at least one processor, cause the at least one processor to carry out the actions described herein, as performed by the UE 10. The computer program product 1505 may be stored on a computer-readable storage medium 1506, e.g. a disc, a universal serial bus (USB) stick or similar. The computer-readable storage medium 1506, having stored thereon the computer program, may comprise the instructions which, when executed on at least one processor, cause the at least one processor to carry out the actions described herein, as performed by the UE 10. In some embodiments, the computer-readable storage medium may be a transitory or a non-transitory computer-readable storage medium.

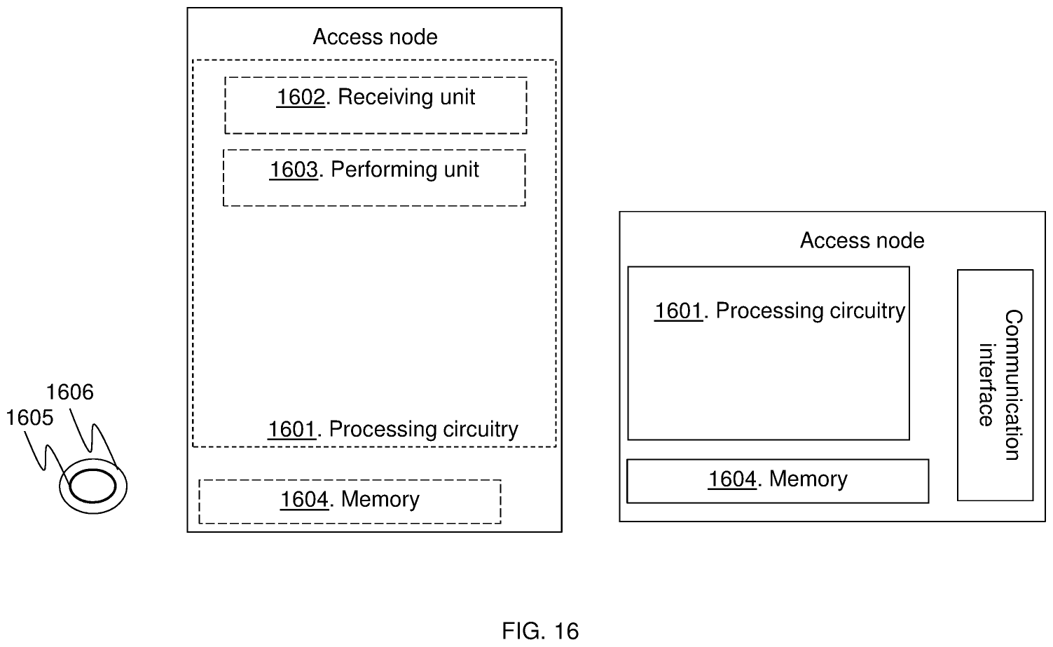

FIG. 16 is a block diagram depicting the access node such as the first or the second radio network node 12,13 for handling establishment of the connection of the UE 10 in the wireless communication network according to embodiments herein.

The access node may comprise processing circuitry 1601, e.g. one or more processors, configured to perform the methods herein.

The access node may comprise a receiving unit 1602, e.g. a receiver, a transceiver or similar. The access node, the processing circuitry 1601, and/or the receiving unit 1602 is configured to receive the message for establishing the connection of the UE, wherein the message comprises the indication of scheduling assistance information for the UE, e.g. the indication or the information in itself indicating scheduling assistance data for the UE 10. The access node, the processing circuitry 1601, and/or the receiving unit 1602 is configured to receive the indication during or at a connection establishment for the UE 10. The message may be one of the following messages: a random access message; a MAC protocol data unit, PDU; a MAC Control Element; an RRCSetupRequest message; an RRCConnectionRequest message; an RRCReestablishmentRequest; an RRCConnectionReestablishmentRequest message; an RRCResumeRequest message; an RRCConnectionResumeRequest; an RRCReconfigurationComplete message; an RRCConnectionReconfigurationComplete message; or a MeasurementReport message. The message may be sent: at RRC connection establishment; at RRC connection re-establishment, at RRC resume or RRC connection resume; at Secondary Cell Group setup or Secondary node addition; at handover; at Secondary Node change while in EN-DC configuration; at resync due to UL inactivity; at resync due to no response on Scheduling request; at resync due to beam recovery; or at request for on demand system information. The scheduling assistance information may be one of, or both of, information obtained by a source radio network node, and information obtained by the UE 10. The scheduling assistance information may comprise amount of uplink data waiting; UE power used when sending message 3; UE measured SINR on signal used as sync source for random access; CSI report; QoS, QCI, 5QI, and/or QFI, of pending UL data; which radio bearer that will be used for the pending UL data; application in the UE to which the pending UL data pertains; and/or active application in the UE. The message may be an RRCResumeRequest message and may contain a short inactive Radio Network Temporary Identifier in order to make room for the indication of the obtained scheduling assistance information.

The access node may comprise a performing unit 1603. The access node, the processing circuitry 1601, and/or the performing unit 1603 is configured to perform an operation associated with scheduling of the UE 10 based on the received indication or information. The access node may perform prioritizations between UEs during scheduling of uplink transmission resources for the UEs based on the received indication.

The access node may a target radio network node of the handover, and the access node, the processing circuitry 1601, and/or the performing unit 1603 may be configured to perform the operation by performing opportunistic scheduling of the UE after a handover using the indicated scheduling assistance information. Performing opportunistic scheduling may comprise using a criterion to determine whether to use opportunistic scheduling or not. The criterion to determine whether to use opportunistic scheduling or not may be based on the indicated scheduling assistance information. The access node may be a distributed node comprising a central unit and a distributed unit, and wherein encrypted RRC messages are decrypted in the central unit and the scheduling assistance information is sent to the distributed unit.

The access node further comprises a memory 1604. The memory comprises one or more units to be used to store data on, such as scheduling assistance information for UEs, transmission parameters, applications to perform the methods disclosed herein when being executed, and similar. The access node may comprise a communication interface e.g. one or more antennas and a network interface.

The methods according to the embodiments described herein for the access node are respectively implemented by means of e.g. a computer program product 1605 or a computer program, comprising instructions, i.e., software code portions, which, when executed on at least one processor, cause the at least one processor to carry out the actions described herein, as performed by the access node. The computer program product 1605 may be stored on a computer-readable storage medium 1606, e.g. a disc, a universal serial bus (USB) stick or similar. The computer-readable storage medium 1606, having stored thereon the computer program, may comprise the instructions which, when executed on at least one processor, cause the at least one processor to carry out the actions described herein, as performed by the access node. In some embodiments, the computer-readable storage medium may be a transitory or a non-transitory computer-readable storage medium.

In some embodiments a more general term “access node” or “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or units may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

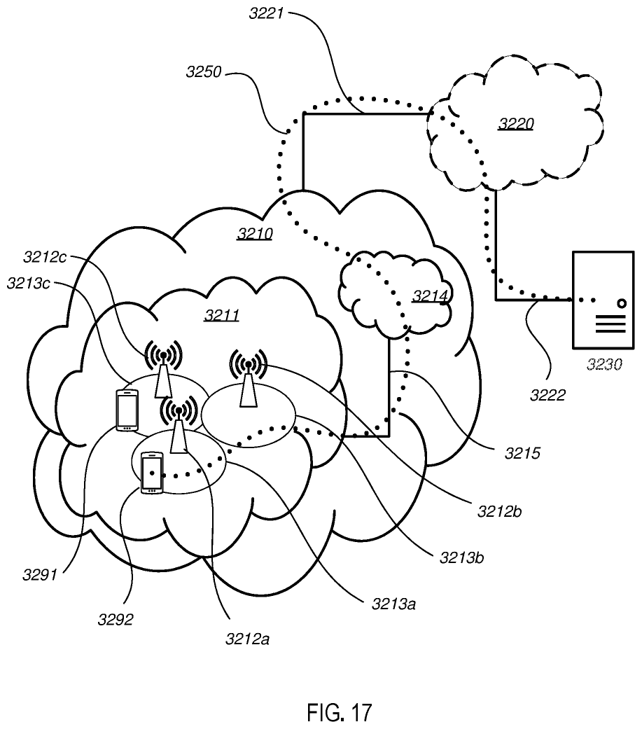

FIG. 17: Telecommunication network connected via an intermediate network to a host computer in accordance with some embodiments

With reference to FIG. 17, in accordance with an embodiment, a communication system includes telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points being examples of the access node above, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example being examples of the UE 10 above, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 17 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

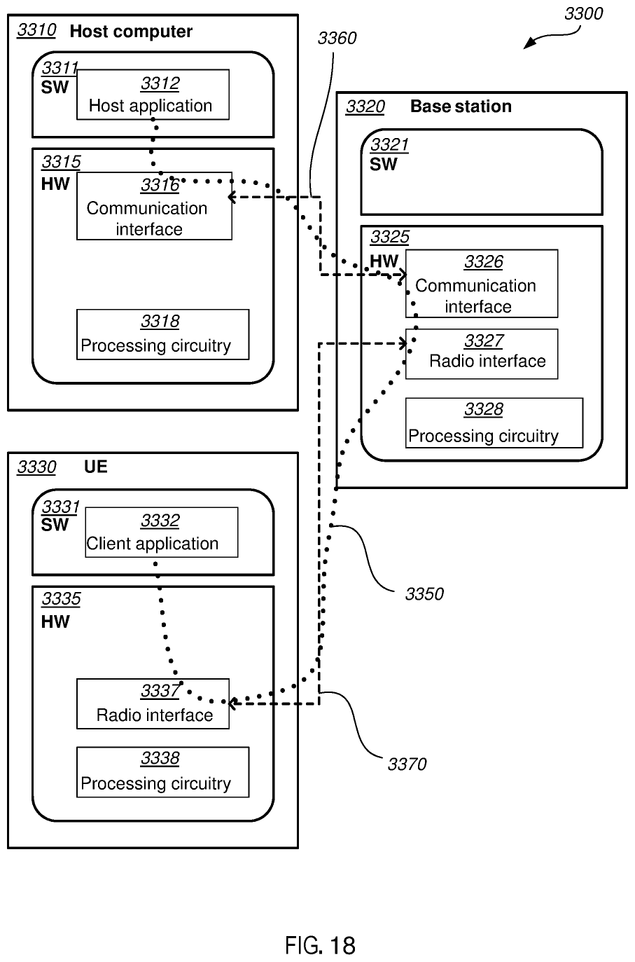

FIG. 18: Host computer communicating via a base station with a user equipment over a partially wireless connection in accordance with some embodiments

Example implementations, in accordance with an embodiment, of the UE, base station and host computer discussed in the preceding paragraphs will now be described with reference to FIG. 18. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 18) served by base station 3320. Communication interface 3326 may be configured to facilitate connection 3360 to host computer 3310. Connection 3360 may be direct or it may pass through a core network (not shown in FIG. 18) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. Its hardware 3335 may include radio interface 3337 configured to set up and maintain wireless connection 3370 with a base station serving a coverage area in which UE 3330 is currently located. Hardware 3335 of UE 3330 further includes processing circuitry 3336, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3336. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 18 may be similar or identical to host computer 3230, one of base stations 3212a, 3212b, 3212c and one of UEs 3291, 3292 of FIG. 17, respectively. This is to say, the inner workings of these entities may be as shown in FIG. 18 and independently, the surrounding network topology may be that of FIG. 17.

In FIG. 18, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments may improve the latency since establishment of connection does not interrupt communication but handled efficiently using the scheduling assistance information and thereby provide benefits such as reduced waiting time and better responsiveness.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signaling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

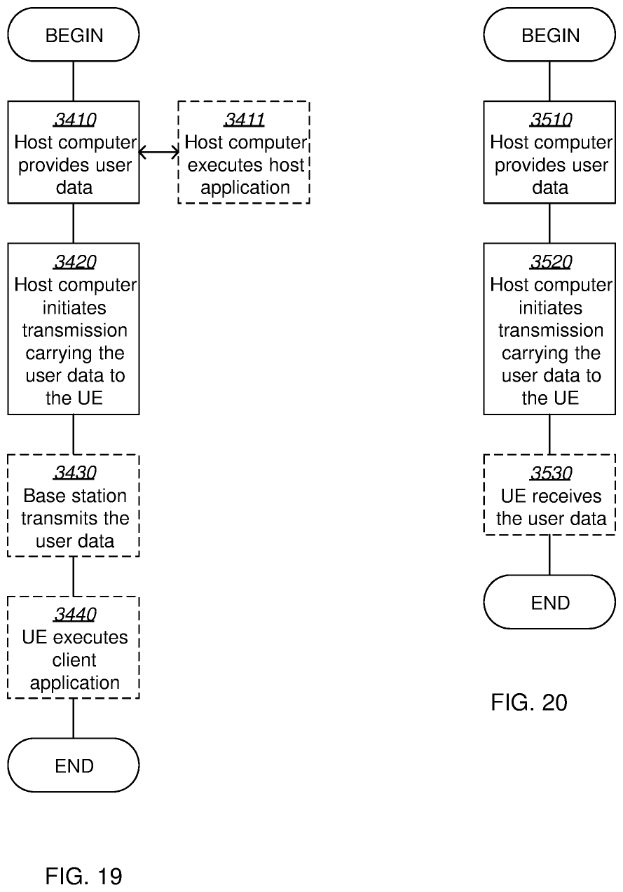

FIG. 19: Methods implemented in a communication system including a host computer, a base station and a user equipment in accordance with some embodiments.

FIG. 19 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 19 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 20: Methods implemented in a communication system including a host computer, a base station and a user equipment in accordance with some embodiments.

FIG. 20 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 20 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

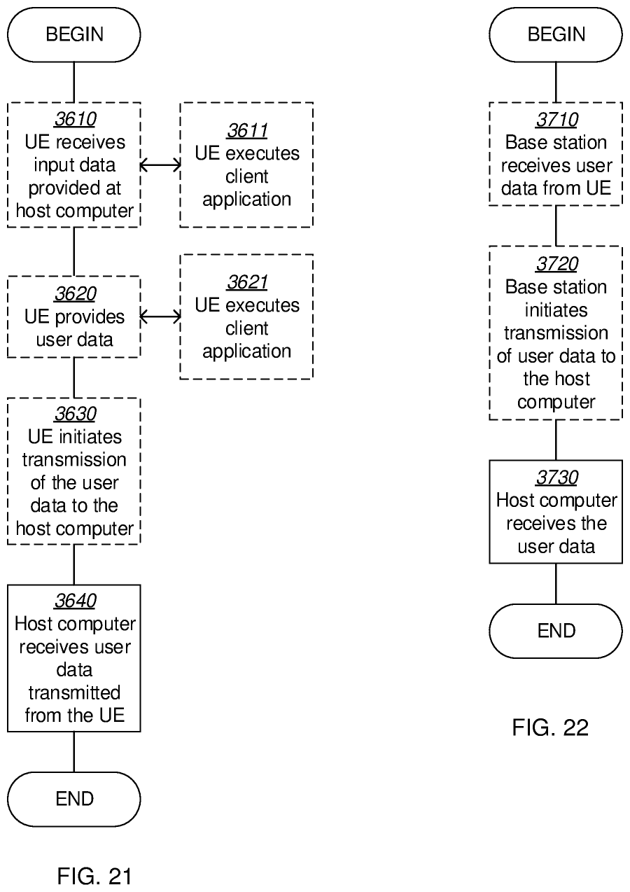

FIG. 21: Methods implemented in a communication system including a host computer, a base station and a user equipment in accordance with some embodiments.

FIG. 21 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 21 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

FIG. 22: Methods implemented in a communication system including a host computer, a base station and a user equipment in accordance with some embodiments.

FIG. 22 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 22 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

| Abbreviation | Explanation |
|---|---|
| 5GS | 5G System |
| 5GC | 5G Core network |
| 5QI | 5G QoS Indicator |
| AMF | Access and Mobility Management Function |
| CHO | Conditional Handover |
| C-RNTI | Cell RNTI |
| DL | Downlink |
| eNB | Evolved Node B |
| eMBB | Enhanced Make-before-break |
| E-UTRAN | Evolved Universal Terrestrial Access Network |
| EPC | Evolved Packet Core network |
| gNB | 5G Node B |
| HO | Handover |
| IE | Information Element |
| IIoT | Industrial Internet of Things |
| LTE | Long-term Evolution |
| MBB | Make-before-break |
| NCC | Next Hop Chaining Counter |
| NG-RAN | Next Generation Radio Access Network |
| NR | New Radio |
| PDCP | Packet Data Convergence Protocol |
| RA | Random Access |
| RAR | Random Access Response |
| RAT | Radio Access Technology |
| RNTI | Radio Network Temporary Identifier |
| RRC | Radio Resource Control |
| Rx | Receive |
| SDU | Service Data Unit |
| SN | Secondary Node |
| SN | Sequence Number |
| sync | synchronization |
| Tx | Transmit |
| UE | User Equipment |
| UL | Uplink |
| UPF | User Plane Function |
| URLLC | Ultra-Reliable Low-Latency Communication |

1.-32. (canceled)

33. A method performed by a user equipment (UE) for handling establishment of a connection of the UE in a wireless communication network, the method comprising:
obtaining scheduling assistance information for the UE; and
transmitting, to an access node, an indication of the obtained scheduling assistance information, wherein the indication is added in a message from the UE to the access node for establishing the connection of the UE.

34. The method according to claim 33, wherein the message is one of the following messages: a random access message; a medium access control (MAC) protocol data unit (PDU); a MAC Control Element; an RRCSetupRequest message; an RRCConnectionRequest message; an RRCReestablishmentRequest; an RRCConnectionReestablishmentRequest message; an RRCResumeRequest message; an RRCConnectionResumeRequest; an RRCReconfigurationComplete message; an RRCConnectionReconfigurationComplete message; or a MeasurementReport message.

35. The method according to claim 33, wherein the scheduling assistance information comprises: an amount of uplink data waiting; UE power used when sending message 3 of a random access procedure; UE measured signal to interference plus noise ratio (SINR) on a signal used as a synchronization source for random access; a channel state information (CSI) report; a quality of service (QoS) Class Identifier (QCI), a 5G QoS Indicator (5QI), and/or a QoS Flow ID (QFI) of pending uplink data; which radio bearer will be used for the pending uplink data; an application in the UE to which the pending uplink data pertains; and/or an active application in the UE.

36. The method according to claim 33, wherein the message is sent: at radio resource control (RRC) connection establishment; at RRC connection re-establishment; at RRC resume or RRC connection resume; at Secondary Cell Group setup or Secondary node addition; at handover; at Secondary Node change while in EN-DC configuration; at resync due to uplink inactivity; at resync due to no response on Scheduling request; at resync due to beam recovery; or at request for on demand system information.

37. The method according to claim 33, wherein the message is an RRCResumeRequest message and contains a short inactive Radio Network Temporary Identifier in order to make room for the indication of the obtained scheduling assistance information.

38. A method performed by an access node for handling establishment of a connection of a user equipment (UE) in a wireless communication network, the method comprising:
receiving a message for establishing the connection of the UE, wherein the message comprises an indication of scheduling assistance information for the UE; and
performing an operation associated with scheduling of the UE based on the received indication.

39. The method according to claim 38, wherein the message is one of the following messages: a random access message; a medium access control (MAC) protocol data unit (PDU); a MAC Control Element; an RRCSetupRequest message; an RRCConnectionRequest message; an RRCReestablishmentRequest; an RRCConnectionReestablishmentRequest message; an RRCResumeRequest message; an RRCConnectionResumeRequest; an RRCReconfigurationComplete message; an RRCConnectionReconfigurationComplete message; or a MeasurementReport message.

40. The method according to claim 38, wherein the message is received: at radio resource control (RRC) connection establishment; at RRC connection re-establishment; at RRC resume or RRC connection resume; at Secondary Cell Group setup or Secondary node addition; at handover; at Secondary Node change while in EN-DC configuration; at resync due to uplink inactivity; at resync due to no response on Scheduling request; at resync due to beam recovery; or at request for on demand system information.

41. The method according to claim 38, wherein either:
the access node is a target radio network node of a handover, the message is received at the handover, and performing the operation comprises performing opportunistic scheduling of the UE after the handover using the indicated scheduling assistance information; or
the access node is a distributed node comprising a central unit and a distributed unit, encrypted radio resource control (RRC) messages are decrypted in the central unit, and the scheduling assistance information is sent to the distributed unit.

42. The method according to claim 38, wherein the scheduling assistance information comprises: an amount of uplink data waiting; UE power used when sending message 3 of a random access procedure; UE measured signal to interference plus noise ratio (SINR) on a signal used as a synchronization source for random access; a channel state information (CSI) report; a quality of service (QoS) Class Identifier (QCI), a 5G QoS Indicator (5QI), and/or a QoS Flow ID (QFI) of pending uplink data; which radio bearer will be used for the pending uplink data; an application in the UE to which the pending uplink data pertains; and/or an active application in the UE.

43. A user equipment (UE) for handling establishment of a connection of the UE in a wireless communication network, wherein the UE comprises:
a communication interface; and
processing circuitry configured to:
obtain scheduling assistance information for the UE; and
transmit, to an access node, an indication of the obtained scheduling assistance information, wherein the indication is added in a message from the UE to the access node for establishing the connection of the UE.

44. The UE according to claim 43, wherein the message is one of the following messages: a random access message; a medium access control (MAC) protocol data unit (PDU); a MAC Control Element; an RRCSetupRequest message; an RRCConnectionRequest message; an RRCReestablishmentRequest; an RRCConnectionReestablishmentRequest message; an RRCResumeRequest message; an RRCConnectionResumeRequest; an RRCReconfigurationComplete message; an RRCConnectionReconfigurationComplete message; or a MeasurementReport message.

45. The UE according to claim 43, w wherein the scheduling assistance information comprises: an amount of uplink data waiting; UE power used when sending message 3 of a random access procedure; UE measured signal to interference plus noise ratio (SINR) on a signal used as a synchronization source for random access; a channel state information (CSI) report; a quality of service (QoS) Class Identifier (QCI), a 5G QoS Indicator (5QI), and/or a QoS Flow ID (QFI) of pending uplink data; which radio bearer will be used for the pending uplink data; an application in the UE to which the pending uplink data pertains; and/or an active application in the UE.

46. The UE according to claim 43, wherein the processing circuitry is configured to send the message: at radio resource control (RRC) connection establishment; at RRC connection re-establishment; at RRC resume or RRC connection resume; at Secondary Cell Group setup or Secondary node addition; at handover; at Secondary Node change while in EN-DC configuration; at resync due to uplink inactivity; at resync due to no response on Scheduling request; at resync due to beam recovery; or at request for on demand system information.

47. The UE according to claim 43, wherein the message is an RRCResumeRequest message and contains a short inactive Radio Network Temporary Identifier in order to make room for the indication of the obtained scheduling assistance information.

48. An access node for handling establishment of a connection of a user equipment (UE) in a wireless communication network, wherein the access node comprises:
a communication interface; and
processing circuitry configured to:
receive a message for establishing the connection of the UE, wherein the message comprises an indication of scheduling assistance information for the UE; and
perform an operation associated with scheduling of the UE based on the received indication.

49. The access node according to claim 48, wherein the message is one of the following messages: a random access message; a medium access control (MAC) protocol data unit (PDU); a MAC Control Element; an RRCSetupRequest message; an RRCConnectionRequest message; an RRCReestablishmentRequest; an RRCConnectionReestablishmentRequest message; an RRCResumeRequest message; an RRCConnectionResumeRequest; an RRCReconfigurationComplete message; an RRCConnectionReconfigurationComplete message; or a MeasurementReport message.

50. The access node according to claim 48, wherein the processing circuitry is configured to receive the message: at radio resource control (RRC) connection establishment; at RRC connection re-establishment; at RRC resume or RRC connection resume; at Secondary Cell Group setup or Secondary node addition; at handover; at Secondary Node change while in EN-DC configuration; at resync due to uplink inactivity; at resync due to no response on Scheduling request; at resync due to beam recovery; or at request for on demand system information.

51. The access node according to claim 48, wherein either:
the access node is a target radio network node of a handover, and the processing circuitry is configured to receive the message at the handover and perform opportunistic scheduling of the UE after the handover using the indicated scheduling assistance information; or
the access node is a distributed node comprising a central unit and a distributed unit, encrypted radio resource control (RRC) messages are decrypted in the central unit, and the scheduling assistance information is sent to the distributed unit.

52. The access node according to claim 48, wherein the scheduling assistance information comprises: an amount of uplink data waiting; UE power used when sending message 3 of a random access procedure; UE measured signal to interference plus noise ratio (SINR) on a signal used as a synchronization source for random access; a channel state information (CSI) report; a quality of service (QoS) Class Identifier (QCI), a 5G QoS Indicator (5QI), and/or a QoS Flow ID (QFI) of pending uplink data; which radio bearer will be used for the pending uplink data; an application in the UE to which the pending uplink data pertains; and/or an active application in the UE.
